(19) United States
(12) Patent Application Publication
(10) Pub. No.: US 2010/0004202 A1
(43) Pub. Date: Jan. 7, 2010

(54) Quaternary ammonium-functionalized-POSS compounds

(75) Inventors: Bret Ja Chisholm, West Fargo, ND (US); Partha Majumdar, Fargo, ND (US)

Correspondence Address: FOLEY & LARDNER LLP, 777 EAST WISCONSIN AVENUE, MILWAUKEE, WI, 53202-5306, US

(73) Assignee: NDSU Research Foundation

(21) Appl. No.: 12/378,155

(22) Filed: Feb. 11, 2009

Related U.S. Application Data
(60) Provisional application No. 61/065,990, filed on Feb. 15, 2008.

(51) Int. Cl. A01N 55/10; C07F 7/10; A01P 15/00

(52) U.S. Cl. 514/63; 556/425

(57) ABSTRACT

A silsesquioxane cage structure has a general formula [R¹SiO_{1.5}]ₙ, wherein, n is an integer greater than or equal to 4; each R¹ is an amine-functional siloxy group, a quaternary ammonium-functional siloxy group, or a texturizing moiety. At least one R¹ group may optionally be a quaternary ammonium-functional siloxy group. Compositions may be prepared from polymers and the silsesquioxane compounds.

### CROSS-REFERENCE TO RELATED APPLICATIONS

This patent application claims the benefit of U.S. Provisional Patent Application 61/065,990, filed on Feb. 15, 2008, the entire contents of which are hereby incorporated by reference, for any and all purposes.

### GOVERNMENT RIGHTS

The United States Government has rights in this invention pursuant to Contract Nos. N00014-05-1-0822 and N00014-06-1-0952 between the United States Government Office of Naval Research and North Dakota State University.

### BACKGROUND

Silsesquioxanes are materials having the general formula [RSiO_{1.5}]ₙ (n≧4). Silsesquioxanes exist in a variety of structures, among which, polyhedral oligomeric silsesquioxane (POSS) compounds are of particular interest as they possess a unique cage like structure and nanoscale dimensions (1-3 nm in diameter). Effective incorporation of POSS into a polymer matrix to produce a nanocomposite can result in increased glass transition temperature, enhanced mechanical properties, increased use temperature, lower flammability, and enhanced rheological properties. POSS compounds may have multiple reactive functionalities that are ideal for the production of unique organic-inorganic hybrid nanomaterials. Functional groups such as epoxy, amine, vinyl, alcohol, carboxylic acid, fluoroalkyl, imide, and halide have been successfully incorporated into POSS structures and used for a variety of applications. Most all of these functionalized POSS compounds are commercially available.

Quaternary ammonium compounds (QACs) are widely used as disinfectants to control microbial growth. Such materials are effective against some bacteria and bacteria spores. They can also kill algae and are used as an additive in large-scale industrial water systems to minimize undesired biological growth. Quaternary ammonium compounds can also be effective disinfectants against enveloped viruses.

### SUMMARY

The present application is directed to silsesquioxanes having quaternized amine functionality. Such materials may be used as antimicrobial agents, disinfecting agents, algicides, etc., in a variety of applications from cleaners to medical devices. The materials typically include a silsesquioxane cage structure of a general formula [R¹SiO_{1.5}]ₙ, where n is greater than or equal to 4, with at least a portion of the silicon atoms of the cage having functionalized siloxy groups attached. Typically, the functionality of the siloxy group is a texturizing moiety, an alkylamine, and/or a quaternary alkyl amine. There may be mixtures of the texturizing moiety, alkyl amine, and quaternary alkyl amine on a cage, although the functionality may be all quaternary alkyl amine. It may also be desirable to include functional groups in the POSS which are capable of serving as sites for cross-linking reactions (“cross-linkable groups”). In some embodiments, the silsesquioxane cage structure compounds also include one or more texturizing moieties, which may be introduced to alter and/or control the physical properties of the material. Such silsesquioxane cage structure compounds may be used in coatings, devices, and the like, where anti-microbial activity is desired. The compounds may also be blended with polymers or reacted with polymers and or precursors thereof to be used in a wide variety of applications. For example, the functionalized silsesquioxane cage structure compounds may be blended with a thermoplastic or elastomeric polymer materials to form coatings in which the compounds may be dispersed in a crosslinked polymer network or incorporated into a crosslinked polymer network.

In one aspect, a compound includes a silsesquioxane cage structure of a general formula [R¹SiO_{1.5}]ₙ, where, n is an integer greater than or equal to 4; each R¹ is independently an amine-functional siloxy group, a quaternary ammonium-functional siloxy group, a texturizing moiety or a cross-linkable group; and at least about 25% of the R¹ groups are quaternary ammonium-functional siloxy groups, amine-functional siloxy groups, or a combination thereof. In other embodiments, the silsesquioxane cage structure includes compounds represented by the formula:

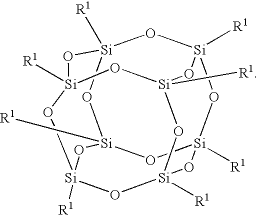

In other embodiments, the amine-functional siloxy group is a group of formula —OSiR²R³(CH₂)ₓNR⁴R⁵; R² and R³ are independently alkyl, cycloalkyl, aralkyl, or aryl; R⁴ and R⁵ are independently H, alkyl, cycloalkyl, aralkyl, aryl, or R⁴ and R⁵, along with the N, form a heterocycloalkyl; and x is an integer from 2 to 25. In other embodiments, the quaternary ammonium-functional siloxy group is a group of formula —OSiR²R³(CH₂)ₓN⁺R⁴R⁵R⁶; R² and R³ are independently alkyl, cycloalkyl, aralkyl, or aryl; R⁴ and R⁵ are independently H, alkyl, cycloalkyl, aralkyl, aryl, or R⁴ and R⁵, along with the N, form a heterocycloalkyl; R⁶ is H, alkyl, cycloalkyl, or aralkyl; and x is an integer from 2 to 25. In other embodiments, about 25% to 75% of the R¹ groups are quaternary ammonium-functional siloxy groups.

In another aspect, methods of preparing the above compounds are provided. In some embodiments, the methods include reacting a silsesquioxane cage compound of formula [R²R³HSiOSiO_{1.5}]ₙ with a compound of formula H₂C═CH(CH₂)ₓNR⁴R⁵ and a vinyl functional texturizing compound to form an amine-functional silsesquioxane cage compound; wherein x is an integer from 2 to 25; n is an integer greater than or equal to 4; R² and R³ are independently alkyl, cycloalkyl, aralkyl, or aryl; and R⁴ and R⁵ are independently H, alkyl, cycloalkyl, aryl, or R⁴ and R⁵, along with the N atom form a heterocycloalkyl group, where the silsesquioxane cage compound is a polyhedral oligomeric silsesquioxane (POSS). In other embodiments, the methods include reacting a compound of formula H₂C═CH(CH₂)ₓNR⁴R⁵ with a polyhedral oligomeric silsesquioxane (POSS) of formula [R¹SiO_{1.5}]ₙ, where, each R¹ is independently a —OSiHR²R³ group or a texturizing moiety to form an amine-functional silsesquioxane cage compound; where, x is an integer from 2 to 25; n is an integer greater than or equal to 4; R² and R³ are independently H, alkyl, cycloalkyl, aralkyl, or aryl; R⁴ and R⁵ are independently H, alkyl, cycloalkyl, aryl, or R⁴ and R⁵, along with the N, form a heterocycloalkyl; and at least one R¹ is a —OSiHR²R³ group. In other embodiments, the methods include reacting the amine-functional silsesquioxane cage compound with a compound of formula R⁶X to form a quaternary ammonium-functional polyhedral oligomeric silsesquioxane; where, R⁶ is an alkyl, cycloalkyl or aralkyl group; and X is a halogen or an R⁶SO₄— group.

Other embodiments include a biocidal composition including polymeric material and a compound that includes a silsesquioxane cage structure of a general formula [R¹SiO_{1.5}]ₙ, where, n is an integer greater than or equal to 4; each R¹ is independently an amine-functional siloxy group, a quaternary ammonium-functional siloxy group, a texturizing moiety or a cross-linkable group; and at least about 25% of the R¹ groups are quaternary ammonium-functional siloxy groups, amine-functional siloxy groups, or a combination thereof. In other embodiments, the polymer material comprises a thermoplastic polymer, an elastomeric polymer, or a blend thereof. In other embodiments, the biocidal composition is a coating on a substrate surface.

In some embodiments, the coating includes at least about 75 wt. % polydialkyl siloxane; and about 5 to 25 wt. % of a compound that includes a silsesquioxane cage structure of a general formula [R¹SiO_{1.5}]ₙ, where, n is an integer greater than or equal to 4; each R¹ is independently an amine-functional siloxy group, a quaternary ammonium-functional siloxy group, a texturizing moiety or a cross-linkable group; and at least about 25% of the R¹ groups are quaternary ammonium-functional siloxy groups, amine-functional siloxy groups, or a combination thereof; where; the amine-functional siloxy group is a group of formula —OSiR²R³(CH₂)ₓNR⁴R⁵; R² and R³ are independently alkyl, cycloalkyl, aralkyl, or aryl; R⁴ and R⁵ are independently H, alkyl, cycloalkyl, aralkyl, aryl, or R⁴ and R⁵, along with the N, form a heterocycloalkyl; and x is an integer from 2 to 25; and where the quaternary ammonium-functional siloxy groups are represented by the formula —OSiR²R³(CH₂)ₓN⁺R⁴R⁵R⁶; and R⁶ is C₁₀-C₁₈ n-alkyl. In other embodiments, about 25% to 75% of the R¹ groups are quaternary ammonium-functional siloxy groups. In other embodiments, the coating is a cross-linked polysiloxane coating. Some embodiments include the silsesquioxane cage structure where n is 8. In other embodiments, R², R³, R⁴, and R⁵ are methyl; x is an integer from 2 to 4; and quaternary ammonium-functional siloxy groups include groups wherein R⁶ is C₁₂ n-alkyl. In other embodiments, R², R³, R⁴, and R⁵ are methyl; x is an integer from 2 to 4; and quaternary ammonium-functional siloxy groups include groups wherein R⁶ is C₁₆ n-alkyl. In other embodiments, R², R³, R⁴, and R⁵ are methyl; x is an integer from 2 to 4; and quaternary ammonium-functional siloxy groups include groups wherein R⁶ is C₁₈ n-alkyl.

In another aspect, methods of preparing coatings are provided. In some embodiments, the methods include reacting a mixture including (A) a tertiaryamino-functional polyhedral oligomeric silsesquioxane and/or an amino-functional polydimethylsiloxane; and (B) a haloalkyl-functional polyhedral oligomeric silsesquioxane and/or a halo-functional polydimethylsiloxane, where the halide is Cl, Br, and/or I; and where the reaction mixture includes at least one of the tertiaryamino-functional polyhedral oligomeric silsesquioxane and the haloalkyl-functional polyhedral oligomeric silsesquioxane.

In another aspect, a biocidal coating is prepared by a method including reacting a mixture including (A) a tertiaryamino-functional polyhedral oligomeric silsesquioxane and/or an amino-functional polydimethylsiloxane; and (B) a haloalkyl-functional polyhedral oligomeric silsesquioxane and/or a halo-functional polydimethylsiloxane, where the halide is Cl, Br, and/or I; and where the reaction mixture includes at least one of the tertiaryamino-functional polyhedral oligomeric silsesquioxane and the haloalkyl-functional polyhedral oligomeric silsesquioxane.

### BRIEF DESCRIPTION OF THE DRAWINGS

FIG. 1 is a graph illustrating the antimicrobial activity of the Q-POSS compounds, according one to embodiment, toward E. coli.

FIG. 2 is a graph illustrating the antimicrobial activity of the Q-POSS compounds, according to one embodiment, toward S. aureus.

FIG. 3 shows results of particle size measurements made on aqueous solutions of the tertiaryamino-functionalized POSS (0 carbon atoms) and Q-POSSs possessing an 8 or 16 carbon alkyl chain.

FIG. 4 shows water contact angle data for coatings based on the 18,000 g/mole HO-PDMS-OH.

FIG. 5 shows water contact angle data for coatings based on the 49,000 g/mole HO-PDMS-OH.

FIG. 6 shows water contact angle hysteresis of coatings plotted as function of alkyl chain length and extent of quaternization of Q-POSS compounds.

FIG. 7 shows AFM images of (A) 18K-C16-QPOSS (high), topography, (B) 18K-C16-QPOSS (high), phase, (C) 18K-C16-QPOSS (low), topography, (D) 18K-C16-QPOSS (low), phase, (E) 18K-C18-QPOSS (high), topography, (F) 18K-C18-QPOSS (high), phase, (G) 18K-C18-QPOSS (low), topography, and (H) 18K-C18-QPOSS (low).

FIG. 8 shows AFM phase images of (A) 18K-C16-QPOSS (low) and (B) 18K-PDMS.

FIG. 9 shows illustrative examples of the antimicrobial responses observed for the coatings used in Example 2.

FIG. 10 shows illustrative examples of the antimicrobial responses observed for the coatings used in Example 17.

### DETAILED DESCRIPTION

### Definitions

POSS is an abbreviation for polyhedral oligomeric silsesquioxane.

Q-POSS is an abbreviation for a quaternized amine-functional polyhedral oligomeric silsesquioxane.

In general, “substituted” refers to an organic group, such as an alkyl group, in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, the term “alkyl” includes straight chain and branched alkyl groups having from 1 to about 25 carbon atoms. Alkyl groups further include cycloalkyl. Examples of straight chain alkyl groups include those with from 1 to 25 carbon atoms such as methyl, ethyl, n-propyl, n-butyl, n-pentyl, n-hexyl, n-heptyl, n-octyl, n-nonyl, n-decyl groups, and the like. Examples of branched alkyl groups include, but are not limited to, isopropyl, iso-butyl, sec-butyl, tert-butyl, neopentyl, isopentyl, 2,2-dimethylpropyl groups, and the like. Representative substituted alkyl groups may be substituted one or more times with substituents.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems, such as, for example bridged cycloalkyl groups as described below, and fused rings, such as, but not limited to, decalinyl, and the like. In some embodiments, polycyclic cycloalkyl groups have three rings. Substituted cycloalkyl groups may be substituted one or more times with, non-hydrogen and non-carbon groups as defined above. Substituted cycloalkyl groups may also include epoxy groups. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Alkenyl groups include straight and branched chain alkyl and cycloalkyl groups as defined above, except that at least one double bond exists between two carbon atoms. Thus, alkenyl groups have from 2 to about 25 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 25 carbon atoms, 5 to 20 carbon atoms, 5 to 10 carbon atoms, or even 5, 6, 7, or 8 carbon atoms. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, hexadienyl, norbornenyl, among others. Representative substituted alkenyl groups may be mono-substituted or substituted more than once, such as, but not limited to, mono-, di- or tri-substituted with substituents such as those listed above.

Aryl groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

Aralkyl groups are alkyl groups as defined above in which a hydrogen or carbon bond of an alkyl group is replaced with a bond to an aryl group as defined above. In some embodiments, aralkyl groups contain 7 to 20 carbon atoms, 7 to 14 carbon atoms or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-ethyl-indanyl. Representative substituted aralkyl groups may be substituted one or more times with substituents such as those listed above.

As used herein, the term “texturizing group” refers to groups that enhance the textural properties of the copolymer and/or the final product which incorporates the copolymer. Such texturizing groups include, but are not limited to hydrophilic groups such as polyether groups, hydrophobic groups such as perfluoroalkyl groups, liquid crystalline groups such as deuterobenzene groups, self-organizing groups, polymers and copolymers such as polymethacrylate including these groups, etc., or a texturizing moiety (e.g., alkoxy alkyl groups such as alkoxy alkyl functional polymethacrylate (either polymer or copolymer), etc.

For the purposes of this disclosure and unless otherwise specified, “a” or “an” means “one or more.”

The word “or” when used without a preceding “either” (or other similar language indicating that “or” is unequivocally meant to be exclusive—e.g., only one of x or y, etc.) shall be interpreted to be inclusive, that is “or” when it appears alone shall mean both “and” and “or.” Likewise, as used herein, the term “and/or” shall also be interpreted to be inclusive in that the term shall mean both “and” and “or.” In situations where “and/or” or “or” are used as a conjunction for a group of three or more items, the group should be interpreted to include one item alone, all of the items together, or any combination or number of the items.

Terms used in the specification and claims such as have, having, include, and including should be construed to be synonymous with the terms comprise and comprising.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

### Description

Quaternary ammonium compounds (QACs) are widely used as antimicrobial agents to inhibit microbial growth. The antimicrobial activity provided by QACs results from both ionic and hydrophobic interactions between the QAC and components of the bacterium cell wall and/or cell membrane that leads to cell death or malfunction in cellular processes. The ability of a QAC to bind to the bacterium cell wall and/or cell membrane and disrupt its function is dependent on various compositional factors such as charge density, amphiphilicity, molecular size, and molecular mobility. Since cell wall/cell membrane composition and structure vary from one microorganism to another, the effectiveness of a given QAC tends to vary from one microorganism to another. The complex relationship between QAC composition, microorganism species, and antimicrobial activity has been previously demonstrated.

Traditionally, QACs containing one or two salt groups have been used as antimicrobial agents in commercial products; however, in nature, compounds containing multiple quaternary ammonium salt (QAS) groups are often used to inhibit biofilm formation. Compared to low molecular weight mono- or divalent QACs, QAS-functional polymers enable higher charge densities that provide higher affinities for the negatively charged microorganism cell wall. However, the higher molecular weight and higher extent of inter- and intramolecular ionic interactions associated with QAS-functional polymers inhibit diffusion through the cell membrane. As a means to enable high charge densities while maintaining a compact molecular structure, Chen et al. investigated QAS-functional poly(propylene imine) dendrimers as an antimicrobial agent and showed that a dendrimer possessing 16 QAS groups per molecule provided two orders of magnitude greater antimicrobial activity than a monofunctional counterpart.

POSS molecules can be readily derivatized to possess as many as eight functional groups per molecule while maintaining a compact molecular size. As previously discussed by Chojnowski et al., Q-POSSs may also have utility as an antimicrobial additive for surface coatings. The excellent biocompatibility and desirable mechanical properties of polysiloxanes has resulted in numerous applications for these materials in the medical industry. Since Q-POSSs possess a siloxane core that should enable compatibility with a siloxane matrix, they may be ideally suited as an antimicrobial additive for polysiloxane coatings.

POSS compounds may be used as the basis for the preparation of quaternary ammonium functional-POSS (Q-POSS) compounds. Such Q-POSS compounds may be incorporated into polymeric matrices to impart both biocidal activity and enhanced mechanical properties to the polymeric material.

Suitable POSS compounds have a silsesquioxane cage structure of a general formula [R¹SiO_{1.5}]ₙ. To conceptually visualize the cage structure, when n is 8, the structure is represented by Formula I:

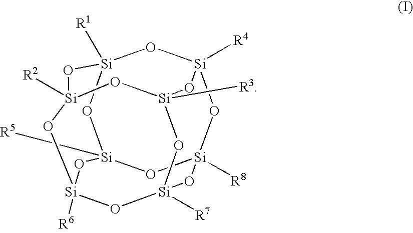

The core of the cage structure is based upon the —O—Si—O—Si—O— network and by varying the magnitude of n, the size of the core structure will change. For example, n may be as small as 4, giving a smaller cage than that illustrated by Formula I, yet n may be quite large ranging from 4 to 30, from 4 to 20, or from 4 to 10. In some embodiments, n is 8, 10, or 12, with 8 being preferred in some instances.

In the silsesquioxane cage structures of general formula [R¹SiO_{1.5}]ₙ, R¹ is an amine-functional siloxy group, a quaternary ammonium-functional siloxy group, a texturizing moiety, or a cross-linkable group. In some embodiments, the amine-functional siloxy groups have the formula —OSiR²R³(CH₂)ₓNR⁴R⁵, where R² and R³ may be the same or different and are alkyl, cycloalkyl, aralkyl, or aryl, and in other embodiments, R⁴ and R⁵ may be the same or different and are H, or an alkyl, cycloalkyl, aralkyl, or aryl, or R⁴ and R⁵, along with the N, form a heterocycloalkyl. In some embodiments, the alkyl is a C₁-C₂₅ alkyl, the cycloalkyl is a C₁-C₁₂ cycloalkyl, the aralkyl contains from 7 to 20 carbon atoms, and the aryl contains from 6 to 20 carbon atoms. In other embodiments, the quaternary ammonium-functional siloxy groups are a group of formula —OSiR²R³(CH₂)ₓN⁺R⁴R⁵R⁶, where R², R³, R⁴, and R⁵ are as defined above, R⁶ is H or is alkyl, cycloalkyl, or aralkyl, and x an integer from 2-25. In some embodiments, x is an integer from 2 to 10, while in other embodiments x is 3.

In some embodiments, R², R³, R⁴, and R⁵ are alkyl groups having from one to twenty carbon atoms, and in other embodiments, they are lower alkyl. For example, R², R³, R⁴, and R⁵ may be methyl, ethyl, propyl, butyl, pentyl, hexyl, heptyl, nonyl, decyl, and the like. In other embodiments, R⁶ is an alkyl group having from 1 to 20 carbon atoms, from 1 to 15 carbon atoms, or from 1 to 10 carbon atoms. For example R⁶ may be methyl, ethyl, propyl, butyl, pentyl, hexyl, heptyl, nonyl, decyl, and the like. For example, they may individually be selected from methyl and ethyl. As these groups are individually selected, they may all be the same. For example, R², R³, R⁴, and R⁵ may all be methyl, or they may all be ethyl. R⁶ may be described as a C₁-C₂₅ alkyl group, while in some embodiments, R⁶ is a C₆-C₁₈ alkyl.

In some cases R¹ may be a texturizing moiety. In some embodiments, the texturizing moiety is a hydrophilic group, such as a polyalkylene ether group. In other embodiments, the texturizing moiety is a hydrophobic group, such as an alkyl group (e.g., a linear alkyl group or a branched alkyl group) or a perfluoroalkyl group. For example, suitable texturizing moieties include vinyl functional texturizing compounds that are vinyl functional polyalkylene ethers or a compound of the formula H₂C═CHR⁷. R⁷ may be a perfluoroalkyl group (e.g., having 6 to 20 carbon atoms) or a linear alkyl group (e.g., having 6 to 20 carbon atoms).

As noted above, it may also be desirable to include functional groups in the POSS which are capable of serving as sites for cross-linking reactions (“cross-linkable groups”). In some embodiments, the an R¹ group may be a crosslinkable groups such as a group derived from an allyl epoxy ether in which the allyl group has reacted with a Si—H group. In some such embodiments, the allyl epoxy ether is allyl glycidyl ether. Cross-linkable groups, such as the epoxy group, provide another manner in which the POSS and Q-POSS materials may be incorporated, or polymerized, into other siloxy or polymeric matrices.

Where the silsesquioxane cage structures of general formula [R¹SiO_{1.5}]ₙ, and only amine-functional siloxy groups and/or texturizing moieties are present, from 0 to n R¹ groups are quaternary ammonium-functional siloxy groups. In other embodiments, at least one R¹ group is a quaternary ammonium-functional siloxy group, in which case the compound is a Q-POSS. In still other embodiments, at least one of each of the three, amine-functional siloxy group, texturizing moiety, and quaternary ammonium-functional siloxy group, are present. In some embodiments, about 25 to 75% of the R¹ groups are quaternary ammonium-functional siloxy groups. Thus, in the silsesquioxane cage structures of general formula [R¹SiO_{1.5}]ₙ, each R¹ may independently be an amine-functional siloxy group or a texturizing moiety; the amine-functional siloxy group is a group of formula —OSiR²R³(CH₂)₃NR⁴R⁵; R², R³, R⁴ and R⁵ are methyl; n is 8; and at least about 25% of the R¹ groups are amine-functional siloxy groups. In another embodiment, each R¹ is an amine-functional siloxy group having a formula —OSiR²R³(CH₂)₃NR⁴R⁵; R², R³, R⁴ and R⁵ are methyl; and n is 8. In yet another embodiment, each R¹ is independently an amine-functional siloxy group of formula —OSiR²R³(CH₂)₃NR⁴R⁵ or a quaternary ammonium-functional siloxy group of formula —OSiR²R³(CH₂)₃N⁺R⁴R⁵R⁶; R², R³, R⁴ and R⁵ are methyl; R⁶ is a linear alkyl group having 6 to 18 carbon atoms; n is 8; and at least about 25% of the R¹ groups are quaternary ammonium-functional siloxy groups.

Functionalization of the POSS compounds with the amine-functional siloxy groups and the quaternary ammonium-functional siloxy groups may change the solubility characteristics of the molecule. For example, in some cases the compounds are soluble in an alcohol whereas the parent POSS with all Si—H groups is not soluble. In some embodiments, the alcohol is methanol, ethanol, propanol, or iso-propanol, with methanol preferred in some cases.

Methods of preparing the amine-functional POSS and Q-POSS materials include the preparation of the amine-functional POSS materials from a POSS silane and an amine compound having a site of unsaturation. The POSS silanes have R¹ as a siloxy group having a Si—H group. For example, in some embodiments the POSS silane has the formula [{R²R³HSiO}SiO_{1.5}]ₙ where R², R³, and n are as defined above. As an example, the compound of formula [{R²R³HSiO}SiO_{1.5}]ₙ may be the compound of Formula II:

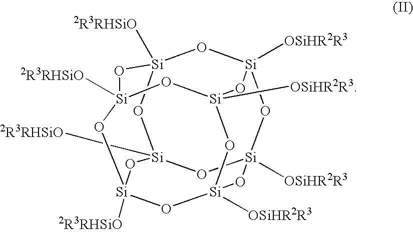

Suitable amine compounds having a site of unsaturation include amines with a vinylic moiety. For example, such amines may have the formula H₂C═CH(CH₂)ₓNR⁴R⁵ where R⁴, R⁵, and x are as defined above. Specific examples of amine-functional alkenyl compounds include, but are not limited to allyldimethylamine, allyldiethylamine, but-3-enyldimethylamine, but-3-enyldiethylamine, allylpiperidine, but-3-enylpiperidine, and the like, as will be recognized by those of skill in the art. The reaction between the POSS and the amine results in a compound of general formula [{NR⁴R⁵(CH₂)ₓR²R³SiO}SiO_{1.5}]ₙ, with n, x, R², R³, R⁴, and R⁵ as defined above.

Alternative methods of preparing the amine-functional POSS and Q-POSS materials include the preparation of a haloalkyl-POSS compound, which can then be reacted with an amine, suitably a tertiary amine, to form the quaternary ammonium-functional POSS materials. Generally in such a method, an alkenyl halide, having a site of unsaturation, may be reacted with a POSS material having Si—H groups. The resulting haloalkyl-POSS compound is then quaternized by reaction with a tertiary amine. The alkenyl halide may be a compound of formula H₂C═CH(CH₂)_{z}X, where z is from 1 to 25, and X is Cl, Br, or I. In some embodiments, X is desirably Cl. Specific examples of the alkenyl halide include, but are not limited to, allyl bromide, allyl iodide, 1-bromo-but-3-ene, 1-iodo-but-3-ene, 1-bromo-pent-4-ene, 1-iodo-pent-4-ene, and the like.

A catalyst is typically used to mediate the reaction of the Si—H groups with the amine-functional or halogen alkenyl compounds. Suitable catalysts are Group VIII transition metals, i.e., the noble metals. Such noble metal catalysts are described in U.S. Pat. No. 3,923,705, incorporated herein by reference for its teaching of platinum catalysts. One such platinum catalyst is Karstedt's catalyst, which is described in Karstedt's U.S. Pat. Nos. 3,715,334 and 3,814,730, incorporated herein by reference. Karstedt's catalyst is a platinum divinyl tetramethyl disiloxane complex typically containing about one-weight percent of platinum in a solvent such as toluene.

Such reactions of the method may be exemplified by the reaction shown in Scheme 1. Scheme 1 illustrates the preparation of an exemplary amine-functional POSS, using allyldimethylamine and a dimethylsiloxane substituted POSS.

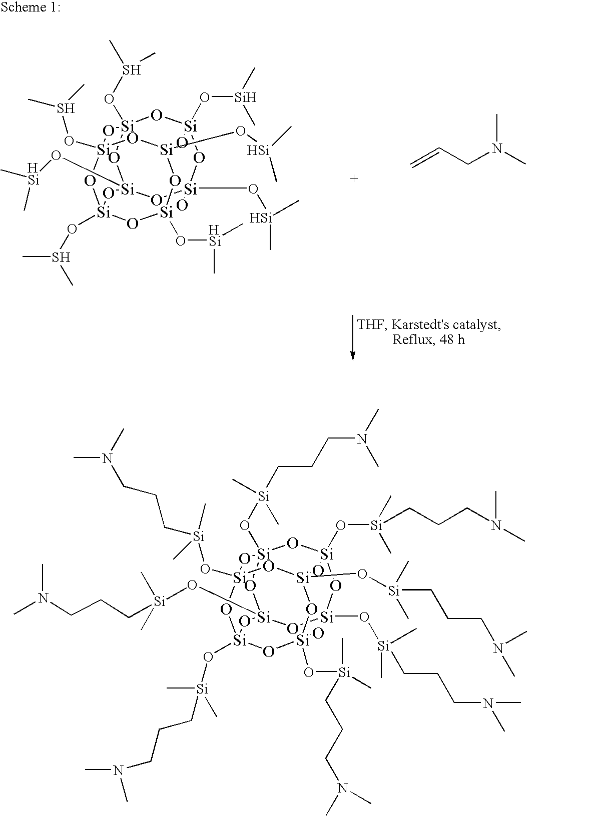

The method may be generally described as reacting a compound of formula H₂C═CH(CH₂)ₓNR⁴R⁵ with a polyhedral oligomeric silsesquioxane (POSS) of formula [R¹SiO_{1.5}]ₙ, where, each R¹ is independently a —OSiHR²R³ group or a texturizing moiety to form an amine-functional silsesquioxane cage compound. In such embodiments, x is an integer from 2 to 25, n is an integer greater than or equal to 4, R² and R³ are independently H, alkyl, cycloalkyl, aralkyl, or aryl, R⁴ and R⁵ are independently H, alkyl, cycloalkyl, aryl, or R⁴ and R⁵, along with the N, form a heterocycloalkyl; and at least one R¹ is a —OSiHR²R³ group. In other embodiments, the amine-functional silsesquioxane cage compound has general formula [R¹SiO_{1.5}]ₙ, each R¹ is independently a —OSiR²R³(CH₂)ₓNR⁴R⁵ group or a texturizing moiety; and at least one R¹ is a —OSiR²R³(CH₂)ₓNR⁴R⁵ group.

As some the silsesquioxane (POSS) of formula [R¹SiO_{1.5}]ₙ, may also contain texturizing moieties, the methods include such embodiments. For example, the method may include reacting a silsesquioxane cage compound of formula [R²R³HSiOSiO_{1.5}]ₙ with a compound of formula H₂C═CH(CH₂)ₓNR⁴R⁵ and a vinyl functional texturizing compound to form an amine-functional silsesquioxane cage compound; wherein x is an integer from 2 to 25; n is an integer greater than or equal to 4; R² and R³ are independently alkyl, cycloalkyl, aralkyl, or aryl; and R⁴ and R⁵ are independently H, alkyl, cycloalkyl, aryl, or R⁴ and R⁵, along with the N atom form a heterocycloalkyl group. In other embodiments, n is 8, 10, or 12. The method may include first reacting the silsesquioxane cage compound with the H₂C═CH(CH₂)ₓNR⁴R⁵ to form an intermediate product; and reacting the intermediate product with the vinyl functional texturizing compound. Alternatively, the method may include first reacting the silsesquioxane cage compound with the vinyl functional texturizing compound to form an intermediate product; and reacting the intermediate product with the H₂C═CH(CH₂)ₓNR⁴R⁵.

Preparation of Q-Poss Compounds May be Accomplished Via Quaternization of the amines of the amine-functional POSS compounds. As noted above, the quaternization of the amine groups may be complete or partial. In other words, all of the amines in the amine-functional POSS materials may be quaternized, or some amine functionality may remain in the Q-POSS materials produced. Remaining amine functionality may be available for further quaternization or other additional functionalization, or may be useful as amine functionality in the Q-POSS materials.

The quaternization reaction is typically the reaction of the amine-functional POSS, described above, with a compound of formula R⁶X to form the Q-POSS materials. Groups suitable for R⁶ are described above. The Q-POSS materials, thus prepared, have the general formula [R¹SiO_{1.5}]ₙ, where, n is an integer greater than or equal to 4, and at least one or more of the R¹ groups has the formula —OSiR²R³(CH₂)ₓN⁺R⁴R⁵R⁶. The quaternization reaction is typically carried out at a temperature of from about 25° C. to about 100° C., from about 25° C. to about 75° C., or from about 40° C. to about 60° C. The quaternization may also be carried out in a solvent in which the amine-functional silsesquioxane cage compound and the R⁶X are soluble, such as tetrahydrofuran, methanol, ethanol, and toluene, among others. The reaction may also be carried out at reflux temperatures, where the temperature is from about 50° C. to about 125° C., or from about 75° C. to about 110° C.

Thus, in some embodiments, the methods of preparation include reacting, an amine-functional polyhedral oligomeric silsesquioxane cage compound with a compound of formula R⁶X to form a quaternary ammonium-functional polyhedral oligomeric silsesquioxane; where R⁶ is an alkyl or cycloalkyl group; and X is a halogen or an R⁶SO₄— group. In other embodiments, the amine-functional silsesquioxane cage compound has general formula [R¹SiO_{1.5}]ₙ, where each R¹ is independently a —OSiR²R³(CH₂)ₓNR⁴R⁵ group or a texturizing moiety; the quaternary ammonium-functional polyhedral oligomeric silsesquioxane has the general formula [R¹SiO_{1.5}]ₙ, where, each R¹ is independently a —OSiR²R³(CH₂)ₓNR⁴R⁵ group, an —OSiR²R³(CH₂)ₓN⁺R⁴R⁵R⁶ group, or a texturizing moiety, and at least one R¹ is a —OSiR²R³(CH₂)ₓN⁺R⁴R⁵R⁶ group; x is an integer from 2 to 25; n is an integer greater than or equal to 4; R² and R³ are independently H, alkyl, cycloalkyl, aralkyl, or aryl; and R⁴ and R⁵ are independently H, alkyl, cycloalkyl, aryl, or R⁴ and R⁵, along with the N, form a heterocycloalkyl.

One exemplary Q-POSS having both amine and quaternary amine functionality, where n is eight, is shown below as Formula III:

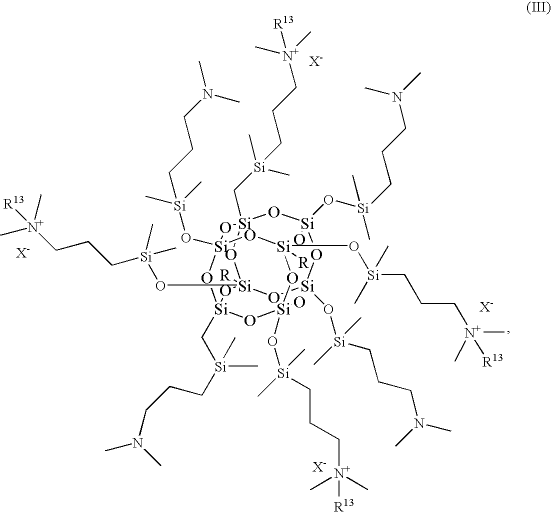

The second reaction of the method may be exemplified by the reaction shown in Scheme 2. Scheme 2 illustrates a preparation of an exemplary amine-functional POSS, using an alkyl halide where the alkyl is any of C₁ to C₁₈ and an amine-functional POSS.

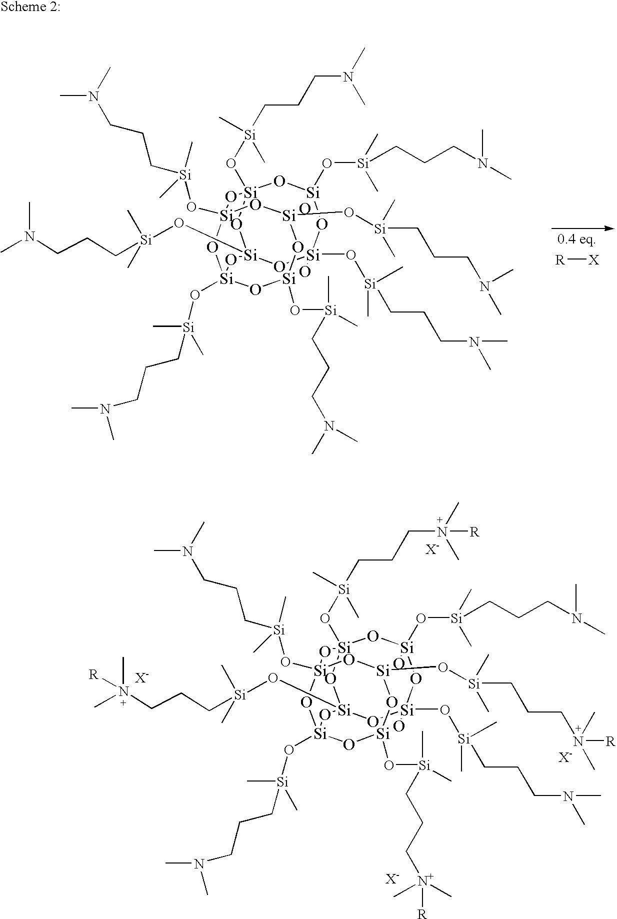

The Q-POSS materials described herein are useful in a wide variety of both releaseable and contact active anti-microbial applications. Compositions of the compounds described may be useful as antimicrobial and/or biocidal compositions. Or such Q-POSS materials may be incorporated in coatings or devices. Additionally, they may be dispersed, or dissolved in polymers that are used in such coating and/or devices. For example, the such anti-microbial coatings may be used on implantable devices such as, but not limited to, urinary catheters and endotracheal tubes. Such polymers can include thermoplastic polymers, elastomeric polymers, or blends thereof.

The present invention, thus generally described, will be understood more readily by reference to the following examples, which are provided by way of illustration and are not intended to be limiting of the present invention.

### EXAMPLES

Materials used in Examples. Octasilane-POSS was purchased from Hybrid Plastics. Allyldimethylamine and N,N-dimethyloctadecylamine were purchased from TCI America. Karstedt's catalyst (platinum(0)-1,3-divinyl-1,1,3,3-tetramethyl disiloxane complex), methyl iodide, 1-iodo-butane, 1-iodo-octane, 1-iodo-dodecane, 1-iodo-hexadecane, 1-iodo-octadecane, toluene, methanol, 1.0 M tetrabutylammonium fluoride (TBAF) in tetrahydrofuran (THF), 4-methyl-2-pentanone, 1-iodohexane, 1-bromooctadecane, 1-bromohexadecane, 1-bromododecane, 1-chlorooctadecane, 1-chlorohexadecane, 1-chlorododecane, 1.0 M tetrabutylammonium fluoride (TBAF) in tetrahydrofuran (THF), 5-bromo-1-pentene, 11-bromo-1-undecene, dibutyltin diacetate (DBTDA), 4-methyl-2-pentanone (MIBK), methyl n-amyl ketone (MAK), and tetrahydrofuran (THF) were obtained from Aldrich Chemical. 18,000 (18K) and 49,000 g/mole (49K) silanol-terminated polydimethylsiloxane (HO-PDMS-OH), methyltriacetoxysilane (MeAc), and hydride terminated polydimethylsiloxane DMS-H11 possessing hydride equivalent weights of 550 g/mol (molecular weight=1000-1100) were purchased from Gelest. Tone 0305 was obtained from Dow Chemical. Tolonate XIDT was supplied by Rhodia. Dowcorning® RTV sealant 734 and Silastic-T2 were obtained from Dowcorning. Intergard 264 epoxy primer, Intersleek tie coat 831, and Intersleek top coat 425 were obtained from International Marine and Protective Coatings. Sherwin Williams Reducer No. 15 was purchased from Sherwin-Williams. For biological assays, tryptic soy broth (TSB), tryptic soy agar (TSA), Luria-Bertani broth (LBB), Luria-Bertani agar (LBA), Sabouraud's dextrose agar (SDA), yeast nitrogen broth (YNB), triphenyltetrazolium chloride, 10× phosphate-buffered saline (PBS), sodium chloride (NaCl), Dey-Engley neutralizing broth (D/E), HPLC grade methanol, glycerol, 33% glacial acetic acid, 0.3% crystal violet in alcohol solution (CV), dextrose monohydrate, magnesium sulfate, 24-well polystyrene plates, 96-well polystyrene plates, and 1.5 ml centrifuge tubes were purchased from VWR International. BacTiter-Glo™ microbial cell viability kit was purchased from Promega Corporation. 0.9% NaCl solution (w/v) was prepared by adding 9 g of NaCl to 1 liter of deionized water. 1 wt % of DBTDA in MAK was prepared for polyurethane formulation. 1× phosphate-buffered saline (PBS) was prepared in deionized water. An 80 weight percent solution of the 49,000 g/mole HO-PDMS-OH in toluene and a 50 mmol solution of TBAF in 4-methyl-2-pentanone (Cat soln.) were used for coating solution preparation. All other reagents were used as received.

Instrumentation. ¹H-NMR spectra were recorded in CDCl₃ on a JEOL 400 MHz spectrometer. A sweep width of 7503 Hz was used with 16k data points, resulting in an acquisition time of 2.184 sec. Sixteen scans were obtained with a relaxation delay of 4 seconds. ²⁹Si-NMR spectra were collected on a JEOL 400 MHz spectrometer operating at 79.43 MHz for ²⁹Si. Acquisition parameters were typically a 62.5 KHz sweep width, 16k data points, and acquisition time of 0.21 sec. Under these conditions 14000 scans were collected. The solvent was d₆-acetone with added chromium tris-acetylacetonate.

### Example 1

Q-POSS synthesis. Octasilane-POSS (2 g, 1.96 mmol) and allyldimethylamine (1.75 g, 20.55 mmol) were dissolved in THF (50 mL) in a 100 ml round-bottom flask equipped with a nitrogen inlet, condenser, and temperature controller. Once dissolved, Karstedt's catalyst (180 μL) was added to the solution and the reaction mixture was refluxed for 48 h. Completion of the reaction was confirmed by the disappearance of the ¹H-NMR (in CDCl₃) peak due to Si—H at δ4.7 ppm. After completion of the hydrosilylation reaction, excess allyldimethylamine was removed under reduced pressure and was confirmed by the absence of ¹H-NMR (in CDCl₃) peaks at δ5.72 ppm (—N—CH₂—CH═) and 5.01 ppm (—N—CH₂—CH═CH₂.

Partial quaternization of the product obtained from the above reaction was carried out by adding 1-iodo-octane (1.52 g, 6.3 mmol). The quaternization reaction was carried out at 50° C. for 48 hours. A substantial increase in viscosity was observed. Using ¹H-NMR (in CDCl₃), new peaks appeared at δ3.5 ppm (—N⁺—CH₂—) and 3.3 ppm [(—N⁺—(CH₃)₂] and a relative decrease of the dimethylamino protons at 2.2 ppm was observed. The extent of quaternization was 40 mole %. THF was removed in vacuo and the resultant Q-POSS was dissolved in methanol (50% solution by weight).

Dimethylamine-functional POSS compounds were quaternized using different alkyl halides as the quaternizing agents. A representative quaternization procedure was as follows: Dimethylamine-functional POSS (9.4×10⁻³ moles of dimethylamine in 2.00 g. of POSS compound) was mixed in a 20 mL vial with 0.90 g of 1-iodo-octane (3.76×10⁻³ moles). The quaternization reaction was carried out at 50° C. for 48 hours. A substantial increase in viscosity was observed. Using ¹H-NMR (in CDCl₃), new peaks appeared at δ3.5 ppm (—N⁺—CH₂—) and 3.3 ppm [(—N⁺—(CH₃)₂] and a relative decrease of the dimethylamino protons at 2.2 ppm was observed. The extent of quaternization was ˜40 mole %. A 30 wt % solution of Q-POSS in THF was prepared. The amount of alkyl halides for each of the quaternization reactions and the extent of quaternization achieved, as determined by ¹H-NMR, are provided in Table 1 and Table 2 respectively.

TABLE 1
Amounts of different quaternizing agents based on 2.00 g of
dimethylamine-functional POSS.

| | 1.20 moles | 0.80 moles | 0.40 moles |
|---|---|---|---|
| Alkyl halide | (wt in grams) | (wt in grams) | (wt in grams) |
| CH₃I | 1.60 | 1.01 | 0.53 |
| C₄H₉I | 2.08 | 1.38 | 0.69 |
| C₈H₁₇I | 2.71 | 1.81 | 0.90 |
| C₁₂H₂₅I | 3.34 | 2.23 | 1.11 |
| C₁₆H₃₃I | 3.97 | 2.65 | 1.32 |
| C₁₈H₃₇I | 4.29 | 2.86 | 1.43 |

TABLE 2
Q-POSS with different extent of quaternization.

| Extent of quaternization | | | |
|---|---|---|---|
| Alkyl halide | High | Medium | Low |
| CH₃I | 63.5 | 42.3 | 18.9 |
| C₄H₉I | 95.1 | 76.4 | 37.6 |
| C₈H₁₇I | 90.5 | 76.9 | 39.7 |
| C₁₂H₂₅I | 94.5 | 71.1 | 37.0 |
| C₁₆H₃₃I | 82.9 | 65.6 | 38.2 |
| C₁₈H₃₇I | 81.7 | 66.9 | 38.9 |

In Table 2, levels of quaternization are defined as high >80%; 80%≧medium>40%; and low is less than or equal to 40%, with the exception in the case of methyl iodide as a quaternizing agent, where the highest extent of quaternization was 63.5%.

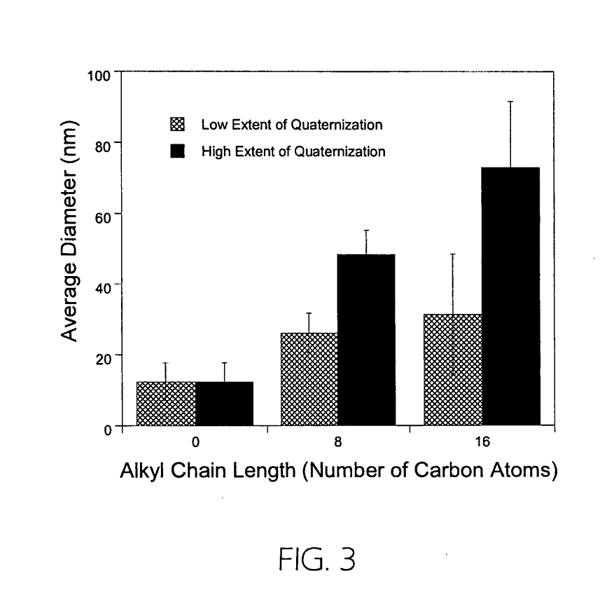

Particle size measurements. Particle size measurements were obtained by dynamic light scattering with a Submicron Particle Sizer Nicomp™ 380 using a 658 nm laser and scattering angle of 90°. Samples were prepared by dissolving 2 μL of 30 wt. % solutions of Q-POSS in THF in 1 ml of 0.9% NaCl (w/v in water). Three measurements were taken for each solution. Results of particle size measurements made on aqueous solutions of the tertiaryamino-functionalized POSS (0 carbon atoms) and Q-POSSs possessing an 8 or 16 carbon alkyl chain are shown in FIG. 3.

Antimicrobial characterization. The antimicrobial activity of the Q-POSS in methanol was determined as follows. Stocks of Escherichia coli ATCC 12435 and Staphylococcus aureus ATCC 25923 were maintained weekly at 4° C. on LBA and TSB, respectively. Broth cultures of E. coli (LBB) and S. aureus (TSB) were prepared by inoculating one colony into 10 ml of broth and incubating at 37° C. with shaking. Overnight cultures were pelleted via centrifugation (10 min at 4500 rpm), washed twice in 0.9% NaCl, and re-suspended to a 0.5 McFarland turbidity standard (˜10⁸ cells/ml). Q-POSS (2 μL) was added to the bacterial suspension (1 mL) previously dispensed into a well of a sterile 24-well polystyrene plate. The plates were then placed on an orbital shaker and allowed to incubate for 2 hrs at room temperature. Each Q-POSS/bacterial suspension (0.1 mL of each) was immediately transferred to D/E neutralization medium (0.9 ml) in a 1.5 mL microcentrifuge tube, and serially diluted (1:10) in D/E medium. Each dilution (0.2 mL) was then transferred in triplicate to a 96-well plate and incubated statically at 37° C. After 24 hr of incubation, the plates were removed from the incubator and photographed with a digital camera to quantify bacterial growth in solution. Bacterial log reductions were reported as the average of three replicate samples. The bacterial suspensions in 0.9% NaCl (without Q-POSS addition) served as a positive growth control (yellow color). Blank D/E medium served as the negative growth control (purple color). Methanol was also evaluated for antimicrobial activity as it was used to solublize the Q-POSS for biological evaluations. Since THF was used to solublize Q-POSS molecules for biological evaluations, the antimicrobial activity of THF was also determined. As expected, THF did not inhibit bacterial growth. Thus, variations in antimicrobial activity could be exclusively attributed to the Q-POSS molecules.

Q-POSS compounds and non-Q-POSS compounds were compared at equal concentration (9.63×10⁻⁵ moles/ml). The results are shown in Table 3.

TABLE 3
Log reduction against E. coli.

| Compounds | | |
|---|---|---|
| QAS-POSS compounds | | |
| Alkyl chain length- | Degree of | |
| counter ion | quaternization(%) | Log Reduction |
| C₈-I | 40 | 7 |
| C₁₂-I | 80 | 7 |
| C₁₂-I | 40 | 7 |
| C₁₆-I | 80 | 7 |
| C₁₆-I | 40 | 7 |
| C₁₈-I | 40 | 5 |

| | |
|---|---|
| non-POSS QAS compounds | |
| Non-TMS-C₁₈-I | 4.7 |
| Benzalkonium chloride | 7.0 |
| (1^{st} generation QAS) | |

The minimum inhibitory concentration (MIC), of Q-POSS compounds and non-Q-POSS compounds were compared and the results are shown in Table 4. As used herein, MIC refers to the lowest concentration of an antimicrobial agent that will inhibit the visible growth of a microorganism after overnight incubation. The procedure was carried out by serially diluting the antimicrobial agent in growth medium and adding the appropriate microorganism. Three 200 μl aliquots of each dilution (inoculated with the appropriate microorganism) were transferred to a 96-well plate and allowed to incubate overnight at the appropriate temperature (37° C. for biomedical microorganisms such as E. coli). The plates were then measured for absorbance at 600 nm to determine microbial growth. The lowest concentration showing an absorbance comparable to a blank medium control (no microorganism added) is considered the MIC.

TABLE 4
MIC values against E. coli.

| Compounds | | |
|---|---|---|
| Q-POSS compounds | | |
| Alkyl chain | Degree of | |
| length-counter ion | quaternization(%) | MIC (μg/ml) |
| C₈-I | 40 | 50 |
| C₁₈-I | 40 | 100 |

| | |
|---|---|
| non-POSS QAS compounds | |
| Non-TMS-C₁₈-I | >100 |
| Benzalkonium chloride | 50 |
| (1^{st} generation Q) | |

### Discussion of Experimental Results

Octasilane-POSS was selected as the starting compound to generate the Q-POSS since the eight Si—H groups are a siloxane unit away from the inorganic cage, resulting in a reduction in steric hindrance for further chemical modification. As shown in Scheme 1, the first step of the Q-POSS synthesis involves hydrosilylation of octasilane-POSS with allyldimethylamine to generate a functionalized POSS, containing eight dimethylamino groups. Complete functionalization was confirmed by ¹H-NMR. ²⁹Si NMR analysis displayed a singlet at δ14.9, corresponding to the M-type silicon, and another singlet at δ-107.3, corresponding to the Q-type silicon of the POSS core. The presence of only two singlets in the ²⁹Si NMR confirms that the cubic structure of POSS has remained intact during the reaction.

The dimethylamino-functionalized-POSS was then used as a precursor to generate the Q-POSS. Quaternization of the dimethylamino-functionalized-POSS was achieved by reaction with 1-iodo-octane at 50° C. for 48 hours.

With each quaternizing agent, the extents of quaternization were varied at three different levels: high (target 100%, ≧81.7% achieved except with methyl iodide), medium (target 80%, ≧65.6% achieved except with methyl iodide), and low (target 40%, ≧37% achieved except with methyl iodide).

Antimicrobial activity of these Q-POSS compounds was measured against the Gram-negative bacterium, E. coli, and against the Gram-positive bacterium, S. aureus. Complex quaternary ammonium salt chemical structure—antimicrobial activity (QASCS-AA) relationships have been observed by other investigators. For example, Gilbert et al. reported a parabolic relationship between the alkyl chain length of alkyl trimethylammonium bromides and antimicrobial activity towards S. aureus, Saccharomyces cerevisiae, and Pseudomonas aeruginosa. Maximum antimicrobial activity was observed for alkyl trimethylammonium bromides possessing 10 and 12 carbon alkyl chains. Similarly, Kourai and coworkers observed a parabolic relationship between the alkyl chain length of N-alkyl-α-methylpyridinium iodides (MP), N-alkyldimethylphenylammonium iodides (dMPh), N-alkyltrimethylammonium iodides (tM), N-alkylquinolinium iodides (Q), and N-alkyl-iso-quinolinium iodides (IQ) and antimicrobial activity toward E. coli and Bacillus subtilis var. niger. For MP, dMPh, and IM, the 16 carbon-based quaternary ammonium compounds displayed the highest antimicrobial activity while the 14 carbon quaternary ammonium compounds were the most potent for Q and IQ. These nonlinear QASCS-AA relationships can be attributed to the interplay among several factors such as the affinity of the quaternary ammonium compound for the cell membrane, aggregational behavior of the quaternary ammonium compound in solution, steric interactions, and the diffusivity of the quaternary ammonium compound through the cell wall. The amphiphilic structure of quaternary ammonium compounds allows both the electrostatic and hydrophobic interactions needed to bind the biocide to the target organism cell wall.

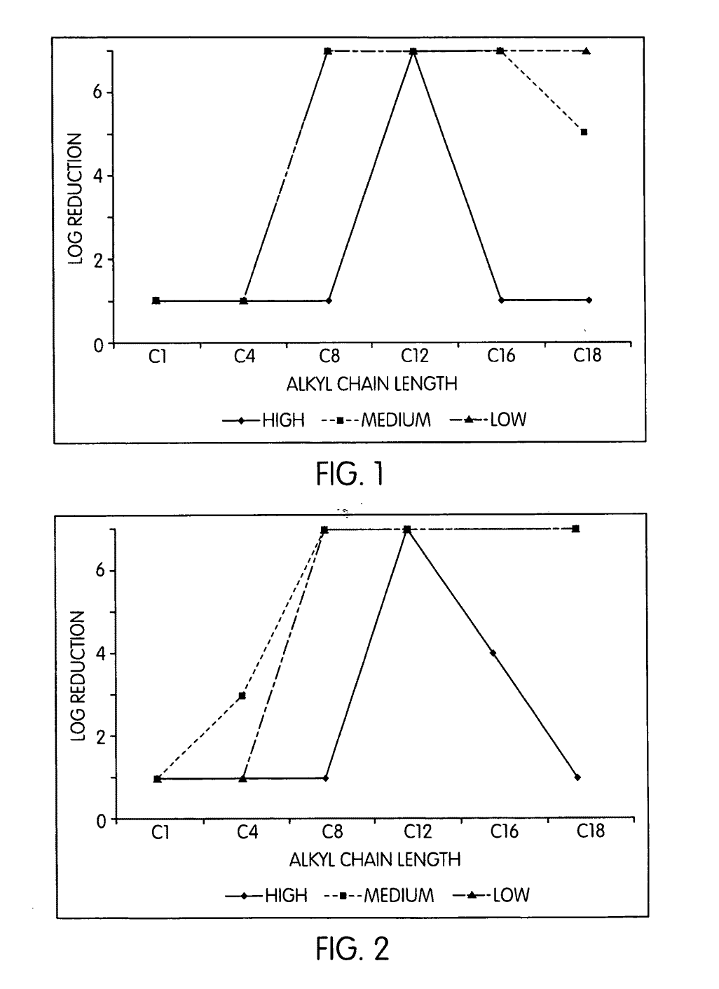

As shown in FIGS. 1 and 2, with Q-POSS compounds, both alkyl chain length and extent of quaternization were found to influence antimicrobial activity against the Gram-negative bacterium, E. coli and the Gram-positive bacterium, S. aureus. Q-POSS compounds with shorter alkyl chains (C₁ and C₄) were found to be inactive against both organisms as relatively short alkyl chain do not possess the lipophilicity needed to effectively bind to the outer surface of the cell structure. Q-POSS compounds with high levels of quaternization had shown a parabolic relationship between the level of activity and alkyl chain length with maximum activity at an alkyl chain length of C₁₂. This might be due to the aggregational behavior of the highly quaternized Q-POSS compounds with long alkyl chains that may not possess the diffusivity to effectively permeate the cell outer layer to cause rupture and cell death.

Particle size measurements of aqueous solutions of the tertiaryamino-functionalized POSS and representative Q-POSS samples were made using dynamic light scattering. The concentration of the solutions used for the measurement was the same as that used for measuring antimicrobial activity. As illustrated in FIG. 3, quaternization of the tertiaryamino-functionalized POSS resulted in a 2 to 6 fold increase in average particle size depending on the level of quaternization and alkyl chain length of the iodo alkane. Increasing the extent of quaternization from the low to the high level resulted in an approximate doubling of particle size. The changes in particle size resulting from quaternization can only be attributed to the formation of Q-POSS aggregates in the solution. The relatively large increase in average particle size observed as a function of alkyl chain length suggests that the driving force for aggregation in aqueous solution was the formation of intermolecular hydrophobic interactions involving the long alkyl chains introduced into the POSS molecules via quaternization. Based on particle size measurements of dilute aqueous solutions, the lower antimicrobial activity of Q-POSSs possessing a relatively high level of quaternization may be attributed to Q-POSS aggregation in solution which inhibited diffusion into bacterial cell walls.

Q-POSS compounds with medium and low degree of quaternizations had shown an increase in activity with the increase in alkyl chain lengths. Low to medium degree of quaternization of POSS might help prevent aggregational behavior of Q-POSS compounds with long alkyl chains. Such behavior would result in favorable hydrophobic interactions needed to bind with the outer surface of the microorganisms.

A representative quaternary ammonium functionalized POSS compound was successfully synthesized using a two step process. First, octasilane POSS was functionalized with dimethylamino groups by hydrosilylation with allyldimethylamine. Next, partial quaternization of the tertiary amino groups was achieved using 1-iodo-octane to produce the Q-POSS. The antimicrobial activity of the Q-POSS toward the Gram-negative bacterium, E. coli, and the Gram-positive bacterium, S. aureus, was determined in solution. The results of the biological assays showed a log 7 reduction in microbial growth for both organisms after a 2 hour exposure time.

Variation in activity, based on bacterial species, may be due to the general differences in the cell membrane structures of Gram-positive and Gram-negative bacteria. Gram-positive bacteria have a loose cell wall that mainly consists of peptidoglycan, while Gram-negative bacteria have a cell wall that consists of two membranes. The inner membrane of the cell wall is based on phospholipids while the outer membrane of the cell wall consists of lipopolysaccharides. Thus, for Gram-negative bacteria, the outer membrane of the cell wall acts as an additional barrier to foreign molecules. Previous results have shown that quaternary ammonium compounds tend to be more effective toward Gram-positive bacteria than Gram-negative bacteria. However, the data shown in FIGS. 1 and 2 show that, in general, there was not much difference in activity of the Q-POSS compounds toward the Gram-positive bacterium and the Gram-negative bacterium.

In a Q-POSS compound, multiple quaternary ammonium groups are attached to a POSS cage. This results in a higher positive charge density in the Q-POSS compounds than in quaternary ammonium compounds without any POSS cage. Formation of a highly charged surface with Q-POSS compounds may be the reason for their activity against both organisms. However, C₄-Q-POSS compound with medium degree of quaternization and C₁₆-Q-POSS compound with high degree of quaternization were found to be slightly more active against S. aureus with log reduction value of 3 and 4, respectively, as compared to log reduction value of 1 against E. coli.

Derivatization of the octasilane-POSS to produce the Q-POSS was found to result in a dramatic change in solubility. The octasilane-POSS, which was insoluble in methanol, was rendered soluble in methanol after the derivatization to Q-POSS.

A 50 wt % solution of Q-POSS in methanol was prepared and the solution tested for antimicrobial activity toward the Gram-negative bacterium, E. coli, and the Gram-positive bacterium, S. aureus. The Q-POSS was found to be highly active toward both organisms providing a log reduction value of 7 for both organisms. These results indicate that Q-POSS materials have the potential to serve as effective antimicrobial agents in solution. In addition, Q-POSS materials may provide antimicrobial activity and possibly mechanical property enhancements to solid-state polymer materials.

### Example 2

Preparation of polysiloxane coatings. Coating solutions were prepared by adding HO-PDMS-OH, Q-POSS solution, and toluene to a 20 ml plastic cup and mixing at 2400 rpm for 2 minutes with a SpeedMixer™ DAC 150 FVE-K. Next, MeAc and Cat sol were added to the mixture and the mixture was mixed at 2400 rpm for an additional 2 minutes. The coating solutions were stirred overnight using magnetic stirring before applying the coatings to substrates. Table 5 describes the compositions of the coating solutions prepared.

TABLE 5
Compositions of the coatings produced (all values are in grams).

| | | | | | | | | Wt % of Q- | | |
|---|---|---|---|---|---|---|---|---|---|---|
| | | | | | | | | POSS | | |
| | 18K- | 49K- | | | Q- | | | (based on | THF | |
| | HO- | OH- | | | POSS | Extent of Q- | Wt of | 100 g of | (from Q- | |
| | PDMS- | PDMS- | | Cat | alkyl | POSS | Q- | HO-PDMS- | POSS | |
| Coating | OH | OH | MeAc | soln. | chain | quaternization | POSS | OH) | solution) | Toluene |
| 18K- | 7.00 | 0.00 | 1.05 | 1.05 | — | — | 0.00 | 0.00 | 0.00 | 0.00 |
| PDMS | | | | | | | | | | |
| 18K-C12- | 7.00 | 0.00 | 1.05 | 1.05 | C₁₂H₂₅— | low | 1.16 | 16.57 | 2.71 | 0.00 |
| QPOSS | | | | | | | | | | |
| (low) | | | | | | | | | | |
| 18K-C16- | 7.00 | 0.00 | 1.05 | 1.05 | C₁₆H₃₃— | low | 1.24 | 17.71 | 2.89 | 0.00 |
| QPOSS | | | | | | | | | | |
| (low) | | | | | | | | | | |
| 18K-C16- | 7.00 | 0.00 | 1.05 | 1.05 | C₁₆H₃₃— | high | 0.79 | 11.29 | 1.84 | 0.00 |
| QPOSS | | | | | | | | | | |
| (high) | | | | | | | | | | |
| 18K-C18- | 7.00 | 0.00 | 1.05 | 1.05 | C₁₈H₃₇— | low | 1.26 | 18.00 | 2.94 | 0.00 |
| QPOSS | | | | | | | | | | |
| (low) | | | | | | | | | | |
| 18K-C18- | 7.00 | 0.00 | 1.05 | 1.05 | C₁₈H₃₇— | high | 0.83 | 11.89 | 1.94 | 0.00 |
| QPOSS | | | | | | | | | | |
| (high) | | | | | | | | | | |
| 49K- | 0.00 | 7.00 | 1.05 | 1.05 | — | — | 0.00 | 0.00 | 0.00 | 1.75 |
| PDMS | | | | | | | | | | |
| 49K-C12- | 0.00 | 7.00 | 1.05 | 1.05 | C₁₂H₂₅— | low | 1.16 | 16.57 | 2.71 | 1.75 |
| QPOSS | | | | | | | | | | |
| (low) | | | | | | | | | | |
| 49K-C16- | 0.00 | 7.00 | 1.05 | 1.05 | C₁₆H₃₃— | low | 1.24 | 17.71 | 2.89 | 1.75 |
| QPOSS | | | | | | | | | | |
| (low) | | | | | | | | | | |
| 49K-C16- | 0.00 | 7.00 | 1.05 | 1.05 | C₁₆H₃₃— | high | 0.79 | 11.29 | 1.84 | 1.75 |
| QPOSS | | | | | | | | | | |
| (high) | | | | | | | | | | |
| 49K-C18- | 0.00 | 7.00 | 1.05 | 1.05 | C₁₈H₃₇— | low | 1.26 | 18.00 | 2.94 | 1.75 |
| QPOSS | | | | | | | | | | |
| (low) | | | | | | | | | | |
| 49K-C18- | 0.00 | 7.00 | 1.05 | 1.05 | C₁₈H₃₇— | high | 0.83 | 11.89 | 1.94 | 1.75 |
| QPOSS | | | | | | | | | | |
| (high) | | | | | | | | | | |

For the generation of coating specimens for antimicrobial testing, coating solutions were cast over primed aluminum discs using 200 μL of coating solution and an Eppendorf Repeater® plus pipetter. The primer used was Intergard 264 epoxy primer. For water contact angle measurements, drawdowns were made over aluminum panels by using a Gardco® applicator. Curing was achieved by allowing the coatings to lie horizontally for 24 hours at ambient conditions followed by a 24 hour heat treatment at 50° C.

Antimicrobial property characterization of coatings containing Q-POSSs. The antimicrobial properties of coatings were determined using an agar plating method. Stocks of E. coli ATCC 12435, S. aureus ATCC 25923, and C. albicans ATCC 10231 were maintained weekly at 4° C. on LBA, TSB, and SDA, respectively. Broth cultures of E. coli (LBB), S. aureus (TSB), and C. albicans (YNB) were prepared by inoculating one colony into 10 ml of broth and incubating at 37° C. with shaking. Overnight cultures were pelleted via centrifugation (10 min at 4500 rpm), washed twice in PBS, and resuspended to a final cell density of ˜10⁸ cells.ml−1. A sterile swab was used to inoculate a lawn of each microorganism on their corresponding agar plates. The coated aluminum discs were then placed on the agar plates with the coated side in direct contact with the agar surface. The plates were inverted and incubated for 24 hours at 37° C. Inhibition of microbial growth around and/or directly on the coating surfaces was evaluated visually from digital images taken after 24 hours of incubation. A biological activity indicator dye, triphenyltetrazolium chloride, was added to the agar medium (70 mg/l E. coli, 15 mg/l S. aureus, 500 mg/l C. albicans) to aid in the visualization of microbial growth (i.e., red color).

Water contact angle and water contact angle hysteresis. Water contact angle and water contact angle hysteresis were determined using an automated surface energy measurement unit manufactured by Symyx Discovery Tools, Incorporated. For the determination of water contact angle hysteresis, advancing contact angle (θ_{A}) was measured by robotically adding water to a water droplet residing on the coating surface using an addition rate of 0.2 μL/s and monitoring changes in contact angle with time; while receding contact angle (θ_{R}) was measured by monitoring contact angle as water was withdrawn from the droplet using a withdrawal rate of 0.2 μL/s. The first image was taken after 20 seconds and subsequent images were taken every 10 seconds. The total duration of the water addition was 70 seconds as was the total duration of water removal. θ_{A} was determined by averaging the second to fifth data points during water addition while θ_{R} was determined by averaging the last four data points. The difference between θ_{A} and θ_{R} was reported as the contact angle hysteresis.

Coating surface morphology. Coating surface morphology was characterized using atomic force microscopy (AFM). The instrument utilized was a Dimension 3100® microscope with a Nanoscope IIIa controller from Veeco Incorporated. Experiments were carried out in tapping mode at ambient conditions and both topographical and phase images were collected. A silicon probe with a spring constant of 0.1-0.4 N/m and resonant frequency of 17-24 kHz was used. The set point ratio for collection of images was 0.8-0.9.

Surface properties of coatings containing Q-POSSs. Q-POSSs which varied with respect to the extent of quaternization and length of the QAS alkyl chain were incorporated into two different moisture-curable polysiloxane coatings and the coating surface properties were characterized using water contact angle and water contact angle hysteresis measurements. The two moisture-curable polysiloxane coatings differed with respect to the molecular weight of the HO-PDMS-OH used to generate the crosslinked network. Scheme 3 provides a representation of schematic representation of the crosslinked PDMS network containing dispersed Q-POSS molecules. Table 6 provides a summary of the coating variables investigated.

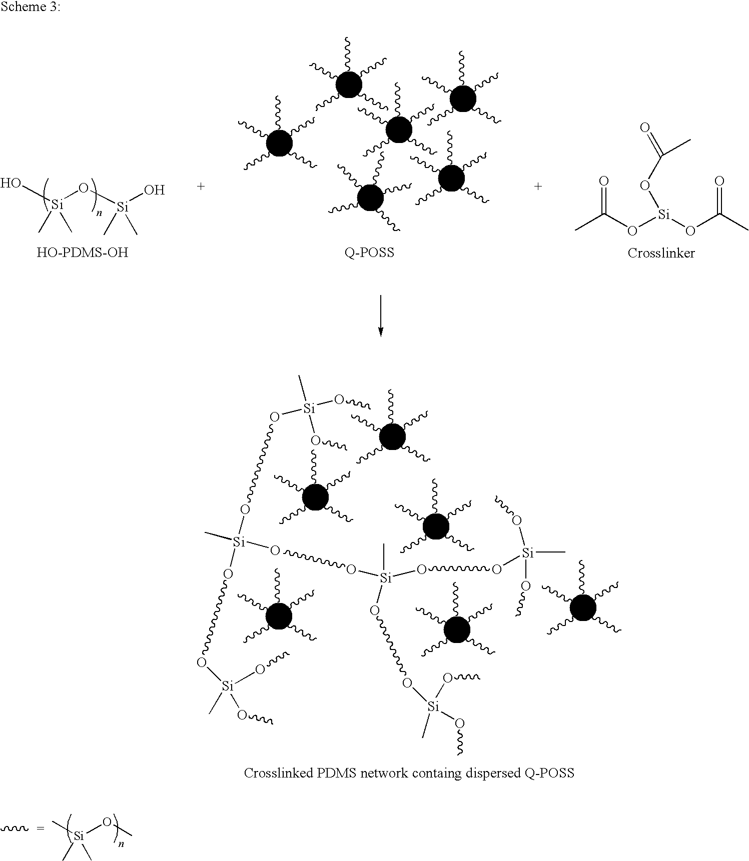

TABLE 6
Description of the coating variables investigated.

| Variable | Level 1 | Level 2 | Level 3 |
|---|---|---|---|
| HO-PDMS-OH molecular | 18,000 | 49,000 | — |
| weight (g/mole) | | | |
| Alkyl chain length | C12 | C16 | C18 |
| Extent of Q-POSS | Low | High | — |
| quaternization | | | |

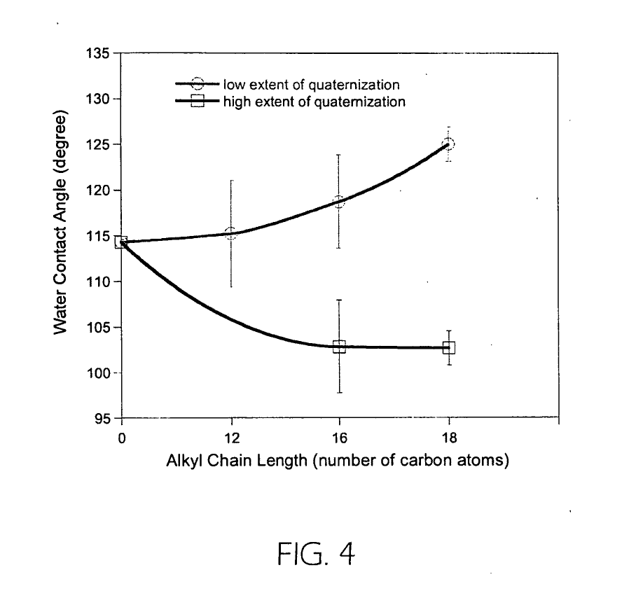

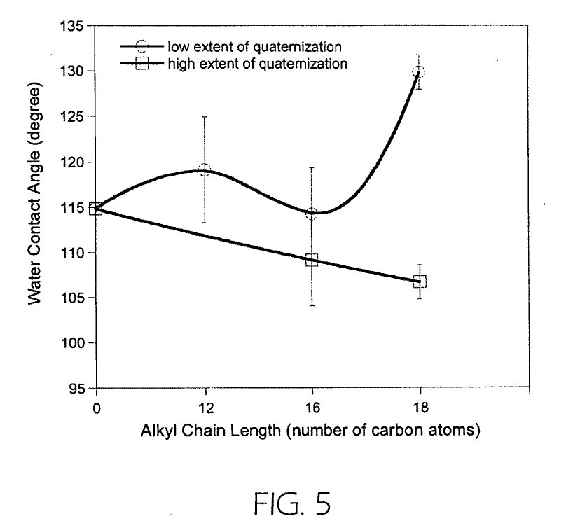

Water contact angle. FIGS. 4 and 5 show water contact angle data as a function of both Q-POSS extent of quaternization and Q-POSS alkyl chain length. For both coating matrices (18K-PDMS and 49K-PDMS), adding Q-POSSs with a low extent of quaternization increased water contact angle while the opposite behavior was observed with the addition of Q-POSSs with a high extent of quaternization. The data show a general trend in which the magnitude of the increase or decrease in water contact angle increases with increasing Q-POSS alkyl chain length. Thus, coatings based on C18-Q-POSS with low extent of quaternization showed the highest water contact angles while coatings based on C18-Q-POSS with the high extent of quaternization showed the lowest water contact angles.

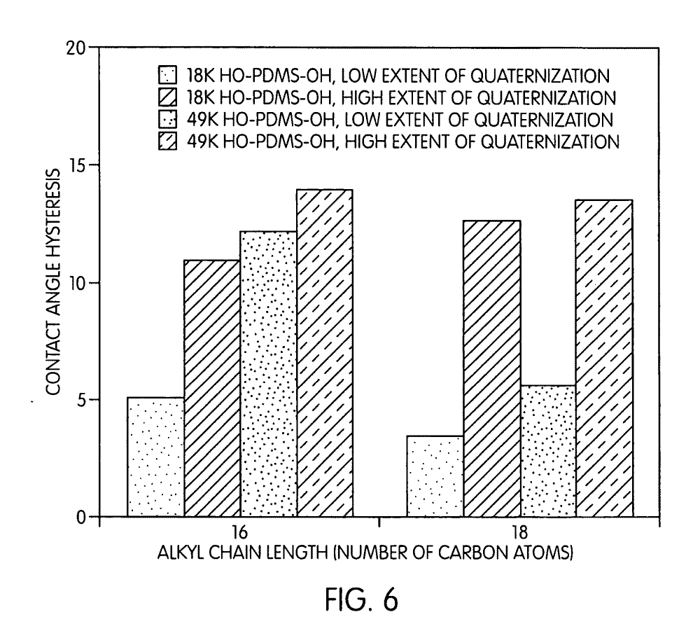

Water contact angle hysteresis (CAH). Water contact angle hysteresis (CAH) was measured. CAH provides a measure of the stability of the coating surface upon exposure to water. The results shown in FIG. 6 indicate that the use of Q-POSSs with a higher extent of quaternization result in a greater change in surface composition and/or morphology upon exposure to water. Considering the hydrophilicity associated with the QAS groups, it would be expected that increasing the extent of Q-POSS quaternization would result in a coating surface that would be more prone to undergo a rearrangement when exposed to the water droplet. The presence of water on the coating surface would provide a thermodynamic driving force for reorganization of QAS groups to maximize molecular interactions between QAS groups and water molecules.

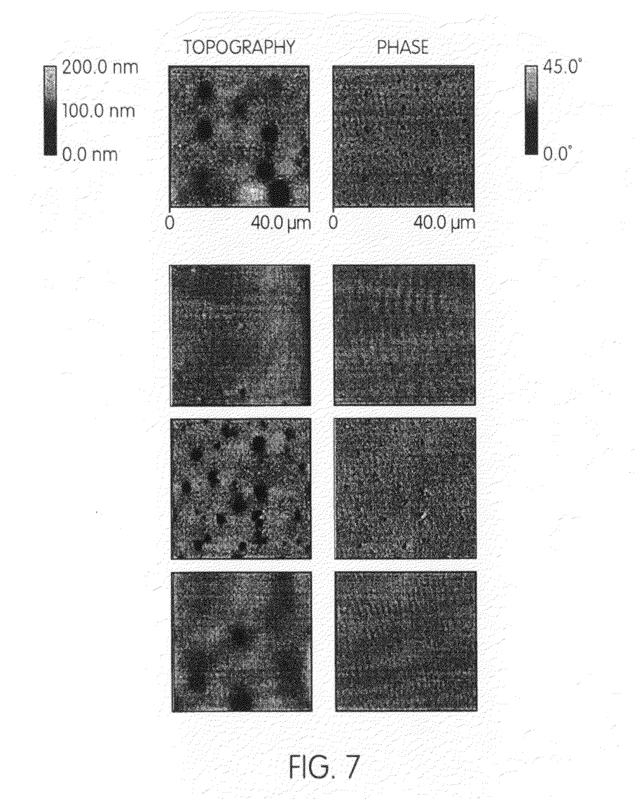

Atomic force microscopy (AFM). AFM was used to characterize coating surface morphology as a function of Q-POSS extent of quaternization. The AFM images displayed in FIG. 7 were all obtained from coatings produced using the same HO-PDMS-OH (18,000 g/mole). A relatively homogeneous surface morphology was obtained for the coatings based on Q-POSSs with the low extent of quaternization (18K-C16-QPOSS (low) and 18K-C18-QPOSS (low)) while a relatively heterogeneous, two-phase surface morphology consisting of dispersed phases in the 2.0 to 4.5 micron size range was observed for the highly quaternized Q-POSS-based coatings (18K-C16-QPOSS (high) and 18K-C18-QPOSS (high)). The micron-sized two-phase surface morphology observed for coatings based on the highly quaternized Q-POSS molecules indicates that the QAS groups provide a thermodynamic driving force for phase separation from the polysiloxane matrix. Most likely intermolecular ionic interactions such as those observed for ionomers is a principle factor in the formation of Q-POSS-rich domains. In addition, intermolecular Van der Waals interactions associated with the long QAS alkyl chains may also contribute to the driving force for phase separation.

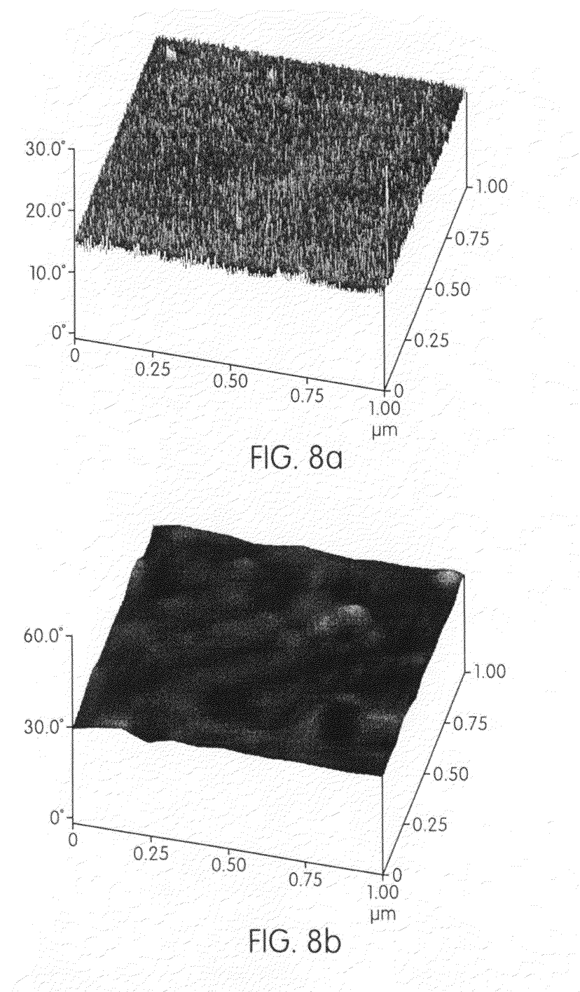

FIG. 8 shows phase images of the pure PDMS matrix (18K-PDMS) and 18K-C16-QPOSS (low) taken at a much higher magnification than the images shown in FIG. 7. At the higher magnification (FIG. 8), it can be seen that the presence of Q-POSS produces a heterogeneous surface morphology at the nanometer scale indicating the presence of the Q-POSS molecules uniformly dispersed at the coating surface. The nanoscale surface topology observed from the QPOSS (low)-containing coatings may contributed to the higher water contact angles observed for these coatings as compared to the Q-POSS-free coatings.

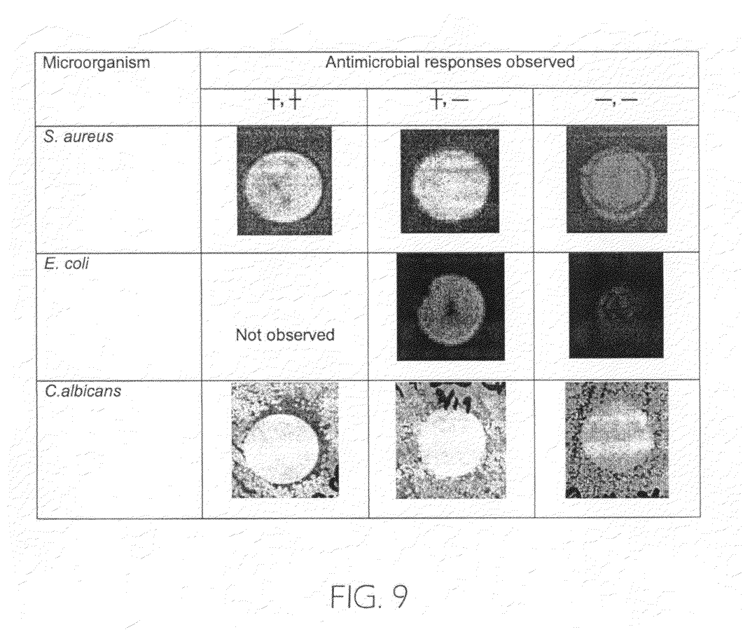

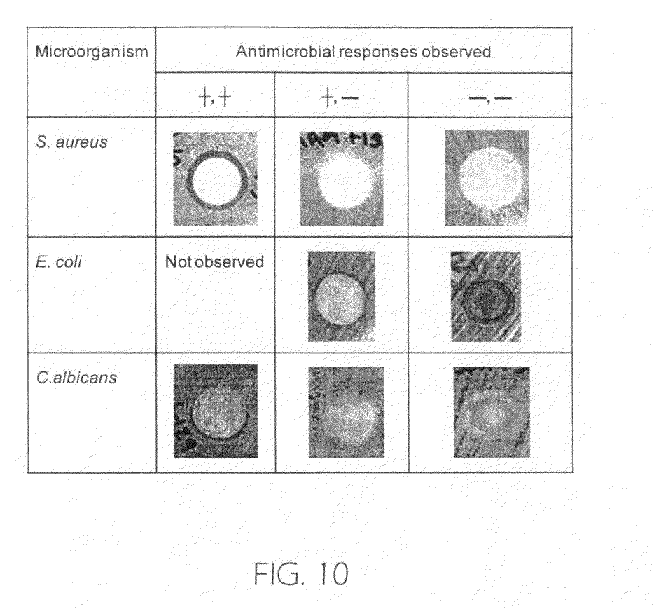

Antimicrobial activity of coatings. The antimicrobial activity of the coatings described in Table 5 were evaluated toward the Gram-positive bacterium, S. aureus, Gram-negative bacterium, E. coli, and the fungal pathogen, C. albicans, using the agar plating method. The antimicrobial properties of the coatings were characterized using visual observation. As illustrated in FIG. 9, three different antimicrobial responses were observed. For some coatings, no microorganism growth was observed on the surface of the coating or in a zone surrounding the coated specimen (zone of inhibition). This type of antimicrobial response was given the designation, “+,+.” In addition to this response, coatings were identified that showed no microorganism growth on the coating surface, but no zone of inhibition. This antimicrobial response was given the designation, “+,−.” Finally, coatings that showed no microorganism growth inhibition on the coating surface or a zone of inhibition were given the designation, “−,−.” A summary of the results obtained from the agar plating method are shown in Table 7.

TABLE 7
Antimicrobial activity of coatings.

| Coating | S. aureus | E. coli | C. albicans |
|---|---|---|---|
| 18K-PDMS | −, − | −, − | −, − |
| 18K-C12-QPOSS (low) | +, + | +, − | −, − |
| 18K-C16-QPOSS (low) | +, − | −, − | +, + |
| 18K-C16-QPOSS (high) | −, − | −, − | −, − |
| 18K-C18-QPOSS (low) | −, − | −, − | +, − |
| 18K-C18-QPOSS (high) | −, − | −, − | −, − |
| 49K-PDMS | −, − | −, − | −, − |
| 49K-C12-QPOSS (low) | +, − | −, − | +, − |
| 49K-C16-QPOSS (low) | +, + | −, − | +, + |
| 49K-C16-QPOSS (high) | −, − | −, − | −, − |
| 49K-C18-QPOSS (low) | +, − | −, − | +, − |
| 49K-C18-QPOSS (high) | −, − | −, − | −, − |

In general, the Q-POSS-containing coatings were much more effective toward S. aureus and C. albicans than E. coli. Only coating 18K-C12-QPOSS (low) showed antimicrobial activity toward E. coli, and only the coatings based on Q-POSSs that possessed the low extent of quaternization displayed antimicrobial activity. The lack of antimicrobial activity for coatings doped with the highly quaternized Q-POSSs may be due to the extensive agglomeration of these Q-POSS molecules within the polysiloxane matrix that inhibits diffusivity of the Q-POSS molecules and thereby limits the ability of the molecules to interact with the cell membrane of the microorganisms. As discussed in Example 1, the driving force for Q-POSS agglomerization likely involves intermolecular interactions associated with the QAS groups. The formation of ionic aggregates in the solid-state for ion-containing polymers has been well documented, and it has been shown that QAS-functional polysiloxanes form ionic aggregates in the solid-state. In addition to intermolecular ionic interactions, intermolecular Van der Waals interactions associated with the long alkyl chain of the QAS groups may contribute to Q-POSS agglomerization. With regard to the effect of HO-PDMS-OH molecular weight on antimicrobial activity, the results in Table 7 indicate that this factor did not have an obvious effect on antimicrobial activity.

For polysiloxane coatings containing Q-POSS compounds as an antimicrobial additive, coating surface energy, surface morphology, and antimicrobial properties were found to be strongly dependent on Q-POSS composition. For coatings based on Q-POSS compounds possessing the low extent of quaternization, water contact angle was increased relative to analogous Q-POSS-free coatings and the coatings possessed nanoscale surface roughness not observed with the Q-POSS-free coatings. These results indicate that the Q-POSS molecules were present at the coating surface. For coatings based on Q-POSSs possessing the high extent of quaternization, a phase separated surface morphology was observed and water contact was lower than analogous Q-POSS-free coatings. The lower water contact angle and presence of a micron-scale dispersed phase at the coating surface suggested significant agglomerization of Q-POSS molecules for these coatings. In addition, coatings possessing the high level of quaternization did not display antimicrobial activity, which may also be due to agglomerization of the Q-POSS molecules. Agglomeration of Q-POSS molecules resulting from extensive intermolecular ionic interactions and possibly intermolecular Van der Waals interactions would be expected to inhibit diffusion and interaction of the Q-POSS molecules with bacterial cells. For coatings exhibiting a zone of inhibition, the zone of inhibition was quite small, indicating low diffusivity of the Q-POSS molecules from the polysiloxane coatings into the agar medium.

### Example 3

In a 100 ml round-bottom flask equipped with a nitrogen inlet, condenser, and temperature controller, 2.00 g of octasilane POSS (1.96 mmol) and 1.75 g of allyldimethylamine (20.55 mmol) were dissolved in 50 ml of THF. Once dissolved, 180 μL of Karstedt's catalyst was added to the reaction mixture and the reaction mixture refluxed for 48 hours. Completion of the reaction was confirmed using proton nuclear magnetic resonance spectroscopy (¹H-NMR) by observing the disappearance of the Si—H peak at δ4.7 ppm. After completion of the hydrosilylation reaction, the final concentration of tertiaryamino-functional POSS was adjusted to 60.0 wt. % in THF. The structure of Example 3 is the structure represented by Formula IV:

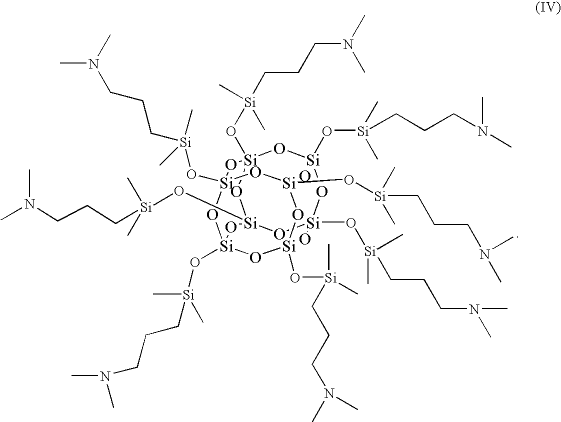

### Example 4

In a 100 ml round-bottom flask equipped with a nitrogen inlet, condenser, and temperature controller, 2.00 g of octasilane POSS (1.96 mmol) and 3.06 g of 5-bromo-1-pentene (20.55 mmol) were dissolved in 50 ml of THF. Once dissolved, 180 μL of Karstedt's catalyst was added to the reaction mixture and the reaction mixture refluxed for 72 hours. Completion of the reaction was confirmed using proton nuclear magnetic resonance spectroscopy (¹H-NMR) by observing the disappearance of the Si—H peak at δ4.7 ppm. After completion of the hydrosilylation reaction, the final concentration of bromo-functional POSS was adjusted to 54.0 wt. % in THF. The structure of Example 4 is the structure represented by Formula V:

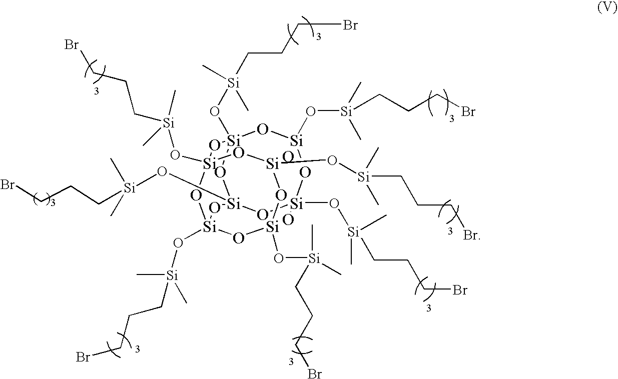

### Example 5

In a 100 ml round-bottom flask equipped with a nitrogen inlet, condenser, and temperature controller, 2.00 g of octasilane POSS (1.96 mmol) and 4.78 g of 11-bromo-1-undecene (20.55 mmol) were dissolved in 50 ml of THF. Once dissolved, 180 μL of Karstedt's catalyst was added to the reaction mixture and the reaction mixture refluxed for 72 hours. Completion of the reaction was confirmed using proton nuclear magnetic resonance spectroscopy (¹H-NMR) by observing the disappearance of the Si—H peak at δ4.7 ppm. After completion of the hydrosilylation reaction, the final concentration of bromo-functional POSS was adjusted to 58.0 wt. % in THF. The structure of Example 5 is the structure represented by Formula VI:

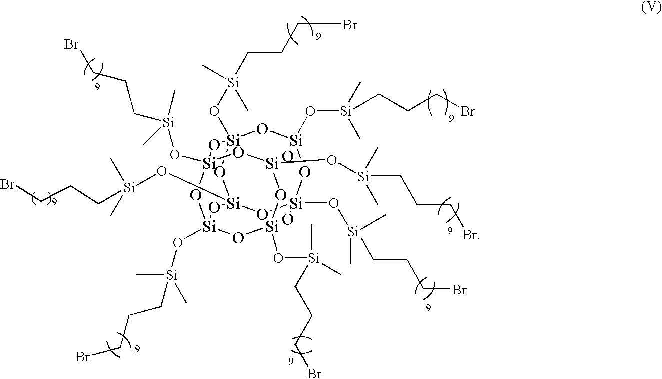

### Example 6

In a 100 mL round-bottom flask equipped with a nitrogen inlet, condenser, and temperature controller, 5.00 g of DMS-H11 possessing a hydride equivalent weight of 550 g/mol (0.0091 mol of hydride) and 0.85 g of allyldimethylamine (0.01 mol) were dissolved in 13.65 g of THF. 180 μL of Karstedt's catalyst was added to the reaction mixture and the reaction mixture refluxed for 72 hours. Completion of the reaction was confirmed using proton nuclear magnetic resonance spectroscopy (¹H-NMR) by observing the disappearance of the Si—H peak at δ4.7 ppm. After completion of the hydrosilylation reaction, the final concentration of tertiaryamino-functional PDMS was adjusted to 84.0 wt. % in THF. The structure of Example 6 is the structure represented by Formula VII:

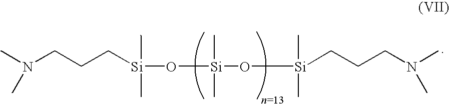

### Example 7

In a 100 mL round-bottom flask equipped with a nitrogen inlet, condenser, and temperature controller, 5.00 g of DMS-H11 possessing a hydride equivalent weight of 550 g/mol (0.0091 mol of hydride) and 1.49 g of 5-bromo-1-pentene (0.01 mol) were dissolved in 15.14 g of THF. 180 μL of Karstedt's catalyst was added to the reaction mixture and the reaction mixture refluxed for 72 hours. Completion of the reaction was confirmed using proton nuclear magnetic resonance spectroscopy (¹H-NMR) by observing the disappearance of the Si—H peak at δ4.7 ppm. After completion of the hydrosilylation reaction, the final concentration of bromo-functional PDMS was adjusted to 73.0 wt. % in THF. The structure of Example 7 is the structure represented by Formula VIII:

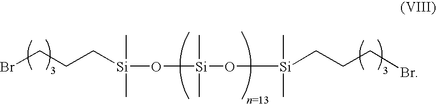

### Example 8

In a 100 mL round-bottom flask equipped with a nitrogen inlet, condenser, and temperature controller, 5.00 g of DMS-H11 possessing a hydride equivalent weight of 550 g/mol (0.0091 mol of hydride) and 2.33 g of 11-Bromo-1-undecene (0.01 mol) were dissolved in 17.10 g of toluene. 180 μL of Karstedt's catalyst was added to the reaction mixture and the reaction mixture was heated at 60° C. for 72 hours. Completion of the reaction was confirmed using proton nuclear magnetic resonance spectroscopy (¹H-NMR) by observing the disappearance of the Si—H peak at δ4.7 ppm. After completion of the hydrosilylation reaction, the final concentration of bromo-functional PDMS was adjusted to 81.0 wt. % in toluene. The structure of Example 8 is the structure represented by Formula IX:

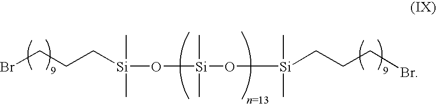

### Example 9

1.69 g of the material prepared in Example 3, 2.40 g of the material prepared in Example 4, 3.28 g of the material prepared in Example 6, and 4.17 g of the material prepared in Example 7 were combined in a 20 ml glass vial. After thoroughly mixing using a vortex mixer, the coating solution was heated overnight at 50° C. under magnetic stirring. After overnight heating and stirring, the coating solution was cooled down to the room temperature and deposited into a 24 well array plate (6 columns and 4 rows) modified with Intergard 264 epoxy primed aluminum discs glued to the bottoms by Dowcorning® RTV sealant 734 in each well. The deposition was done such that a given coating composition occupied an entire column of the 24 well array plate (4 replicate coatings per array plate). The volume of coating solution transferred to each well was 0.25 mL. The coating was allowed to cure for 72 h an oven at 50° C.

### Example 10

1.69 g of the material prepared in Example 3, 2.40 g of the material prepared in Example 4, 3.28 g of the material prepared in Example 6, and 4.25 g of the material prepared in Example 8 were combined in a 20 ml glass vial. After thoroughly mixing using a vortex mixer, the coating solution was heated overnight at 50° C. under magnetic stirring. After overnight heating and stirring, coating deposition and curing were done using the same procedure described for Example 9.

### Example 11

1.69 g of the material prepared in Example 3, 2.89 g of the material prepared in Example 5, 3.28 g of the material prepared in Example 6, and 4.25 g of the material prepared in Example 8 were combined in a 20 ml glass vial. After thoroughly mixing using a vortex mixer, the coating solution was heated overnight at 50° C. under magnetic stirring. After overnight heating and stirring, coating deposition and curing were done using the same procedure described for Example 9.

### Example 12

1.69 g of the material prepared in Example 3 and 2.89 g of the material prepared in Example 5 were combined in a 20 ml glass vial. After thoroughly mixing using a vortex mixer, the coating solution was kept under magnetic stirring at room temperature overnight. After overnight stirring, coating deposition and curing were done using the same procedure described for Example 9.

### Example 13

Preparation of Reference silicone standard Intersleek 425: Intersleek top coat 425 was deposited over Intersleek tie coat 381. Intersleek tie coat was prepared by mixing 8.0 g of part A, 8.0 g of part B, and 3.2 g of Sherwin Williams Reducer No. 15 at room temperature. After through mixing, the coating solution was deposited using the same procedure described for Example 9. The volume of coating solution transferred to each well was 0.15 mL. The tie coat was kept at room temperature for 24 hr before the deposition of Intersleek top coat 425. Intersleek top coat 425 was prepared by mixing 15.0 g of part A, 4.0 g of part B, and 1.0 g of part C at room temperature. After through mixing, the coating solution was deposited into a 24 well array plate (6 columns and 4 rows) modified with Intersleek tie coat 381. The deposition was done such that it occupied an entire column of the 24 well array plate (4 replicate coatings per array plate). The volume of coating solution transferred to each well was 0.15 mL. Coating was allowed to cure for 24 hr at room temperature.

### Example 14

Preparation of Reference silicone standard Silastic-T2: Silastic-T2 was prepared by mixing 6.5 g of Silastic-T2 resin, 0.5 g of curing agent, and 7.0 g of Sherwin Williams Reducer No. 15 at room temperature. After through mixing, the coating solution was deposited using the same procedure described for Example 9. The volume of coating solution transferred to each well was 0.20 mL. Coating was allowed to cure for 24 hr at room temperature.

### Example 15

Preparation of Reference polyurethane coating: The Polyurethane coating was prepared by dissolving 3.9 g. of Tone Polyol 0305, 10.9 g. of Tolonate XIDT, and 0.097 g. of a 1.0 weight percent solution of DBTDA in MAK in 6.21 g. of Sherwin Williams Reducer No. 15. After through mixing, the coating solution was deposited using the same procedure described for Example 9. The volume of coating solution transferred to each well was 0.20 mL. Coating was allowed to cure at room temperature for 24 hr.

### Example 16

Biofilm retention assay. The procedure used for the biofilm retention assay is as follows: Array plates were inoculated with a 1.0 mL suspension of C. lytica in BGM (˜10⁷ cells/mL) after 14 days of immersion in a recirculating water bath. The plates were then incubated statically in a 28° C. incubator for 18 hours to facilitate bacterial attachment and subsequent colonization. The plates were then rinsed three times with 1.0 mL of deionized water to remove any planktonic or loosely-attached biofilm. The biofilm retained on each coating surface after rinsing was then stained with crystal violet dye. Once dry, the crystal violet dye was extracted from the biofilm with the addition of 0.5 mL of glacial acetic acid and the resulting eluate was measured for absorbance at 600 nm. The absorbance values (A) were directly proportional to the amount of biofilm retained on the coating surface. Percent reductions in biofilm retention over example coatings were calculated using the following equation:

$$Reduction in biofilm retention ( \% ) = \frac{( \begin{matrix}{A}_{mean} of reference coating - \\ {A}_{mean} of example coating\end{matrix} )}{{A}_{mean} of reference coating} \times 100$$

The results obtained for C. lytica biofilm retention are shown in Table 8.

TABLE 8
Percent reduction in C. lytica biofilm retention

| | Reduction against | Reduction against | Reduction against |
|---|---|---|---|
| Coating | Intersleek 425 (%) | Silastic-T2 (%) | Polyurethane (%) |
| Example 9 | 36.4 | 46.3 | 40.8 |
| Example 10 | 47.9 | 55.9 | 51.4 |
| Example 11 | 66.7 | 71.9 | 69.0 |
| Example 12 | 62.2 | 67.9 | 64.6 |

The results show that up to 71.9% reduction in C. lytica biofilm retention was achieved on example coating as compare to reference coating. Scheme 4 provides a representation of the crosslinked network produced by in situ quaternization in the Example 9-12 coating solutions.

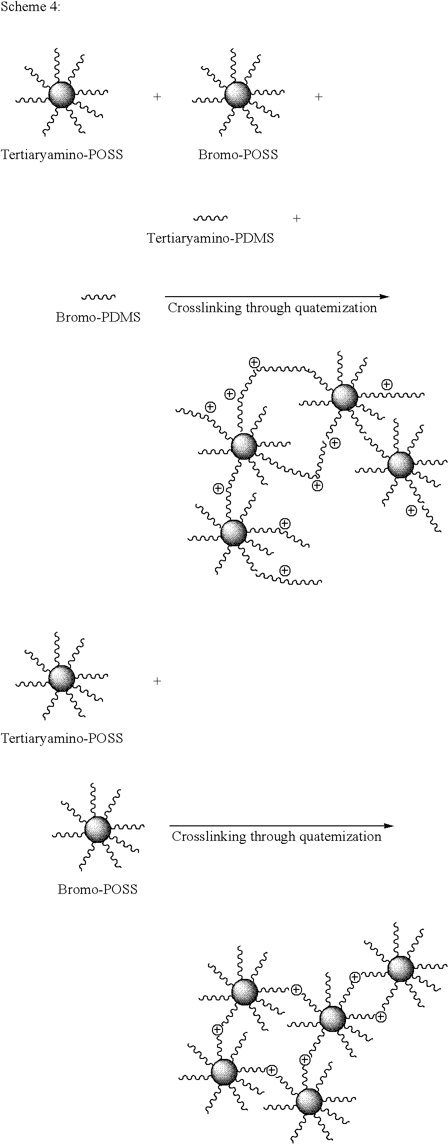

### Example 17

Composition of Q-POSS compounds: The tertiaryamino-functional POSS compound was converted to Q-POSSs by quaternization using alkyl halides. Table 9 lists the composition Q-POSSs used as additives to generate polysiloxane-based coatings.

TABLE 9
Composition of Q-POSS compounds.

| | Alkyl | Counter | Extent of quaternization |
|---|---|---|---|
| Q-POSS | chain length | ion | (High ~ 100%, Low ~ 40%) |
| Q-18(low)-Cl | —C₁₈H₃₇ | Cl | Low |
| Q-16(low)-I | —C₁₆H₃₃ | I | Low |
| Q-16(high)-I | —C₁₆H₃₃ | I | High |
| Q-12(low)-Cl | —C₁₂H₂₅ | Cl | Low |
| Q-12(low)-Br | —C₁₂H₂₅ | Br | Low |

Synthesis of non-POSS quaternary ammonium compound: Non-POSS quaternary ammonium compound QAS-C18-I was synthesized by mixing 5.0 g of 1-iodohexane with 6.66 g of N,N-dimethyloctadecylamine in a 20 ml vial and heating the reaction mixture at 110° C. for 48 hours using magnetic stirring. After cooling the reaction to room temperature, methanol was added to each vial to produce a 50 percent (wt./wt.) solution of the QAC in methanol.

Antimicrobial testing of coatings: The antimicrobial properties of the coated aluminum discs were determined using an agar plating method. Stocks of Escherichia coli ATCC 12435, Staphylococcus aureus ATCC 25923 and C. albicans ATCC 10231 were maintained weekly at 4° C. on LBA, TSB and SDA, respectively. Broth cultures of E. coli (LBB), S. aureus (TSB), and C. albicans (YNB) were prepared by inoculating one colony into 10 ml of broth and incubating at 37° C. with shaking. Overnight cultures were pelleted via centrifugation (10 min at 4500 rpm), washed twice in PBS, and resuspended to a final cell density of ˜10⁸ cells.ml⁻¹. A sterile swab was used to inoculate a lawn of each microorganism on their corresponding agar plates. The coated aluminum discs were then placed on the agar plates with the coated side in direct contact with the agar surface. The plates were inverted and incubated for 24 hours at 37° C. Inhibition of microbial growth around and/or directly on the coating surfaces was evaluated visually from digital images taken after 24 hours of incubation. A biological activity indicator dye, triphenyltetrazolium chloride, was added to the agar medium (70 mg/l E. coli, 15 mg/l S. aureus, 500 mg/l C. albicans) to aid in the visualization of microbial growth (i.e., red color).

Antimicrobial responses of coatings: The antimicrobial properties of the coatings were characterized using visual observation after their testing using an agar plating method. As illustrated in FIG. 10, three different antimicrobial responses were observed. For some coatings, no microorganism growth was observed on the surface of the coating or in a zone surrounding the coated specimen (zone of inhibition). This type of antimicrobial response was given the designation, “+,+.” In addition to this response, coatings were identified that showed no microorganism growth on the coating surface, but no zone of inhibition. This antimicrobial response was given the designation, “+,−.” Finally, coatings that showed no microorganism growth inhibition on the coating surface or a zone of inhibition were given the designation, “−,−.”

### Trial 1

For Trial 1a, coating solutions were prepared by adding 7.0 g of 18K-HO-PDMS-OH and 1.24 g of Q-16(low)-I solution to a 20 ml plastic cup and mixing at 2400 rpm for 2 minutes with a SpeedMixer™ DAC 150 FVE-K. Next, 1.05 g of MeAc and 1.05 g of Cat sol were added to the mixture and the mixture mixed at 2400 rpm for an additional 2 minutes. The coating solution was stirred overnight using magnetic stirring before applying the coatings to substrates. For the generation of coating specimens for antimicrobial testing, the coating solution was cast over primed aluminum discs using 200 μLs of coating solution and an Eppendrof Repeaters plus pipetter. The primer used was Intergard 264 epoxy primer. Curing was achieved by allowing the coatings to lie horizontally for 24 hours at ambient conditions followed by a 24 hour heat treatment at 50° C.

The composition of Trial 1b was the same as Trial 1a with the exception that 0.79 g of Q-16(high)-I solution was used in place of Q-16(low)-I solution. The material preparation used for Trial 1b was the same as used for Trial 1a.

The composition of Trial 1c was the same as Trial 1a with the exception that 49K-HO-PDMS-OH was used in place 18K-HO-PDMS-OH. The material preparation used for Trial 1c was the same as used for Trial 1a.

The composition of Trial 1d was the same as Trial 1b with the exception that 49K-HO-PDMS-OH was used in place 18K-HO-PDMS-OH. The material preparation used for Trial 1d was the same as used for Trial 1b.

For Reference 1a, 7.0 g of 18K-HO-PDMS-OH, 1.05 g of MeAc, and 1.05 g of Cat sol were added to a 20 ml plastic cup and mixed at 2400 rpm for 2 minutes with a SpeedMixer™ DAC 150 FVE-K. The coating solution was stirred overnight using magnetic stirring before applying the coatings to substrates. For the generation of coating specimens for antimicrobial testing, coating solution was cast over primed aluminum discs using 200 μLs of coating solution and an Eppendrof Repeater® plus pipetter. The primer used was Intergard 264 epoxy primer. Curing was achieved by allowing the coatings to lie horizontally for 24 hours at ambient conditions followed by a 24 hour heat treatment at 50° C.

The composition of Reference 1b was the same as Reference 1a with the exception that 49K-HO-PDMS-OH was used in place 18K-HO-PDMS-OH. The material preparation used for Reference 1b was the same as used for Reference 1a.

The results displayed in Table 10 show that only the Trial coatings (1a and 1c) based on Q-POSSs that possessed the low extent of quaternization displayed antimicrobial activity. No antimicrobial activity was observed for Reference coatings.

TABLE 10
Antimicrobial activity of coatings.

| Coating | S. aureus | C. albicans |
|---|---|---|
| Trial 1a | +, − | +, + |
| Trial 1b | −, − | −, − |
| Trial 1c | +, + | +, + |
| Trial 1d | −, − | −, − |
| Reference 1a | −, − | −, − |
| Reference 1b | −, − | −, − |

### Trial 2

The composition of Trial 2a was the same as Trial 1a with the exception that 1.03 g of Q-12(low)-Cl solution was used in place of Q-16(low)-I solution. The material preparation used for Trial 2a was the same as used for Trial 1a.

The composition of Trial 2b was the same as Trial 1a with the exception that 1.09 g of Q-12(low)-Br solution was used in place of Q-16(low)-I solution. The material preparation used for Trial 2b was the same as used for Trial 1a.

The composition of Trial 2c was the same as Trial 2a with the exception that 49K-HO-PDMS-OH was used in place 18K-HO-PDMS-OH. The material preparation used for Trial 2c was the same as used for Trial 2a.

The composition of Trial 2d was the same as Trial 2b with the exception that 49K-HO-PDMS-OH was used in place 18K-HO-PDMS-OH. The material preparation used for Trial 2d was the same as used for Trial 2b.

The compositions of Reference 2a and 2b were the same as Reference 1a and 1b respectively. The material preparation used for Reference 2a and 2b were the same as used for Reference 1a.

The results displayed in Table 11 show that both the composition of the Q-POSS and the composition of the polysiloxane matrix affected antimicrobial properties. Trial coatings based on Q-12(low)-Cl or Q-12(low)-Br and 18K-HO-PDMS-OH (Trials 2a and 2b) were found to be active against all three microorganisms. No antimicrobial activity was observed for Reference coatings.

TABLE 11
Antimicrobial activity of coatings.

| Coating | S. aureus | E. coli | C. albicans |
|---|---|---|---|
| Trial 2a | +, + | +, − | +, + |
| Trial 2b | +, + | +, − | +, + |
| Trial 2c | +, − | −, − | −, − |
| Trial 2d | −, − | −, − | −, − |
| Reference 2a | −, − | −, − | −, − |
| Reference 2b | −, − | −, − | −, − |

### Trial 3

The composition of Trial 3a is the same as Trial 1a with the exception that 1.28 g of Q-18(low)-I solution was used in place of Q-16(low)-I solution. The material preparation used for Trial 3a is the same as used for Trial 1a.

For Reference 3a, 7.0 g of 18K-HO-PDMS-OH, 1.43 g of QAS-C18-I in methanol, 1.05 g of MeAc, and 1.05 g of Cat sol were added to a 20 ml plastic cup and mixed at 2400 rpm for 2 minutes with a SpeedMixer™ DAC 150 FVE-K. The coating solution was stirred overnight using magnetic stirring before applying the coatings to substrates. For the generation of coating specimens for antimicrobial testing, coating solution was cast over primed aluminum discs using 200 μLs of coating solution and an Eppendrof Repeater® plus pipetter. The primer used was Intergard 264 epoxy primer. Curing was achieved by allowing the coatings to lie horizontally for 24 hours at ambient conditions followed by a 24 hour heat treatment at 50° C.

The results displayed in Table 12 show that only the Trial coating based on Q-18(low)-I as Q-POSS displayed antimicrobial activity. No antimicrobial activity was observed for Reference coating based on non-POSS quaternary ammonium compound QAS-C18-I.

TABLE 12
Antimicrobial activity of coatings.

| Coating | S. aureus | C. albicans |
|---|---|---|
| Trial 3a | +, − | +, − |
| Reference 3a | −, − | −, − |

### Illustrative Embodiments

A number of illustrative embodiments of the present methods and compositions are described below. The embodiments described are intended to provide illustrative examples of the present methods and compositions and are not intended to limit the scope of the invention.

In one embodiment, a compound has a silsesquioxane cage structure of a general formula [R¹SiO_{1.5}]ₙ, where n is an integer greater than or equal to 4; and each R¹ is independently an amine-functional siloxy group, a quaternary ammonium-functional siloxy group, a texturizing moiety, or a cross-linkable group. In some embodiments, the amine-functional siloxy group is a group of formula —OSiR²R³(CH₂)ₓNR⁴R⁵; R² and R³ are independently alkyl, cycloalkyl, aralkyl, or aryl; R⁴ and R⁵ are independently H, alkyl, cycloalkyl, aralkyl, aryl, or R⁴ and R⁵, along with the N, form a heterocycloalkyl; and x is an integer from 2 to 25. In other embodiments, the quaternary ammonium-functional siloxy group is a group of formula —OSiR²R³(CH₂)ₓN⁺R⁴R⁵R⁶; R² and R³ are independently alkyl, cycloalkyl, aralkyl, or aryl; R⁴ and R⁵ are independently H, alkyl, cycloalkyl, aralkyl, aryl, or R⁴ and R⁵, along with the N, form a heterocycloalkyl; R⁶ is H, alkyl, cycloalkyl, or aralkyl; and x is an integer from 2 to 25. In other embodiments, the texturizing moiety is a hydrophilic group, such as a polyalkylene ether group. In other embodiments, the texturizing moiety is a hydrophobic group, such as an alkyl group (e.g., a linear alkyl group or a branched alkyl group) or a perfluoroalkyl group. In other embodiments, R², R³, R⁴, and R⁵ are independently methyl or ethyl. In other embodiments, R², R³, R⁴, and R⁵ are methyl. In other embodiments, R², R³, R⁴, and R⁵ are ethyl. In other embodiments, x is an integer from 2 to 10. In other embodiments, x is 3. In other embodiments, R⁶ is C₁-C₂₅ alkyl. In other embodiments, R⁶ is C₆-C₁₈ alkyl. In other embodiments, n is an integer from 4 to 20. In other embodiments, n is 8, 10, or 12. In other embodiments, at least one of the R¹ groups are quaternary ammonium-functional siloxy groups. In other embodiments, n is from 4 to 20 and from 0 to n R¹ groups are quaternary ammonium-functional siloxy groups. In other embodiments, about 25 to 75% of the R¹ groups are quaternary ammonium-functional siloxy groups. In other embodiments, the silsesquioxane cage structure is represented by the formula:

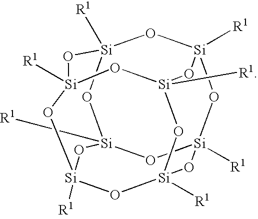

In other embodiments, zero R¹ groups are quaternary ammonium-functional siloxy groups. In other embodiments, the compound is soluble in an alcohol. In some embodiments, the alcohol is methanol.

In yet other embodiments, each R¹ is independently an amine-functional siloxy group or a texturizing moiety; the amine-functional siloxy group is a group of formula —OSiR²R³(CH₂)₃NR⁴R⁵; R², R³, R⁴ and R⁵ are methyl; n is 8; and at least about 25% of the R¹ groups are amine-functional siloxy groups. While in other embodiments, each R¹ is an amine-functional siloxy group having a formula —OSiR²R³(CH₂)₃NR⁴R⁵; R², R³, R⁴ and R⁵ are methyl; and n is 8.

In some embodiments, each R¹ is independently an amine-functional siloxy group of formula —OSiR²R³(CH₂)₃NR⁴R⁵ or a quaternary ammonium-functional siloxy group of formula —OSiR²R³(CH₂)₃N⁺R⁴R⁵R⁶; R², R³, R⁴ and R⁵ are methyl; R⁶ is a linear alkyl group having 6 to 18 carbon atoms; n is 8; and at least about 25% of the R¹ groups are quaternary ammonium-functional siloxy groups.

In another aspect, methods of preparing the above compounds are provided. In some embodiments, the methods include reacting a compound of formula H₂C═CH(CH₂)ₓNR⁴R⁵ with a polyhedral oligomeric silsesquioxane (POSS) of formula [R¹SiO_{1.5}]ₙ, where, each R¹ is independently a —OSiHR²R³ group or a texturizing moiety to form an amine-functional silsesquioxane cage compound; wherein, x is an integer from 2 to 25; n is an integer greater than or equal to 4; R² and R³ are independently H, alkyl, cycloalkyl, aralkyl, or aryl; R⁴ and R⁵ are independently H, alkyl, cycloalkyl, aryl, or R⁴ and R⁵, along with the N, form a heterocycloalkyl; and at least one R¹ is a —OSiHR²R³ group. In other embodiments, the reacting step is carried out in the presence of a catalyst. In other embodiments, the catalyst is a platinum catalyst. In other embodiments, the platinum catalyst is Karstedt's catalyst.

In other embodiments, the amine-functional silsesquioxane cage compound has general formula [R¹SiO_{1.5}]ₙ, each R¹ is independently a —OSiR²R³(CH₂)ₓNR⁴R⁵ group or a texturizing moiety; and at least one R¹ is a —OSiR²R³(CH₂)ₓNR⁴R⁵ group.

In another aspect, methods of preparing the Q-POSS materials are provided. In some embodiments, the methods include reacting, an amine-functional polyhedral oligomeric silsesquioxane cage compound with a compound of formula R⁶X to form a quaternary ammonium-functional polyhedral oligomeric silsesquioxane; wherein; R⁶ is an alkyl or cycloalkyl group; and X is a halogen or an R⁶SO₄— group.

In other embodiments, the amine-functional silsesquioxane cage compound has general formula [R¹SiO_{1.5}]ₙ, where, each R¹ is independently a —OSiR²R³(CH₂)ₓNR⁴R⁵ group or a texturizing moiety; the quaternary ammonium-functional polyhedral oligomeric silsesquioxane has the general formula [R¹SiO_{1.5}]ₙ, where, each R¹ is independently a —OSiR²R³(CH₂)ₓNR⁴R⁵ group, an —OSiR²R³(CH₂)ₓN⁺R⁴R⁵R⁶ group, or a texturizing moiety, and at least one R¹ is a —OSiR²R³(CH₂)ₓN⁺R⁴R⁵R⁶ group; x is an integer from 2 to 25; n is an integer greater than or equal to 4; R² and R³ are independently H, alkyl, cycloalkyl, aralkyl, or aryl; and R⁴ and R⁵ are independently H, alkyl, cycloalkyl, aryl, or R⁴ and R⁵, along with the N, form a heterocycloalkyl. In some embodiments, in the —OSiR²R³(CH₂)ₓN⁺R⁴R⁵R⁶ group, R², R³, R⁴ and R⁵ are methyl; and R⁶ is a linear alkyl group containing 8 to 18 carbon atoms. In other embodiments, the reacting step is carried out at a temperature of from about 25° C. to about 100° C., from about 25° C. to about 75° C., or from about 40° C. to about 60° C. In other embodiments, the reaction is carried out in a solvent in which the amine-functional silsesquioxane cage compound and the R⁶X are soluble, such as tetrahydrofuran, toluene, methanol, or ethanol. In other embodiments, the reaction is carried out at from about 50° C. to about 125° C., or from about 75° C. to about 110° C.

In another aspect, methods of preparing the POSS materials are provided. In some embodiments, the methods include reacting a silsesquioxane cage compound of formula [R²R³HSiOSiO_{1.5}]ₙ with a compound of formula H₂C═CH(CH₂)ₓNR⁴R⁵ and a vinyl functional texturizing compound to form an amine-functional silsesquioxane cage compound; where x is an integer from 2 to 25; n is an integer greater than or equal to 4; R² and R³ are independently alkyl, cycloalkyl, aralkyl, or aryl; and R⁴ and R⁵ are independently H, alkyl, cycloalkyl, aryl, or R⁴ and R⁵, along with the N atom form a heterocycloalkyl group, where the silsesquioxane cage compound is a polyhedral oligomeric silsesquioxane (POSS). In other embodiments, n is 8, 10, or 12. In other embodiments, the methods comprise first reacting the silsesquioxane cage compound with the H₂C═CH(CH₂)ₓNR⁴R⁵ to form an intermediate product; and reacting the intermediate product with the vinyl functional texturizing compound. In other embodiments, the methods comprise first reacting the silsesquioxane cage compound with the vinyl functional texturizing compound to form an intermediate product; and reacting the intermediate product with the H₂C═CH(CH₂)ₓNR⁴R⁵. In other embodiments, the vinyl functional texturizing compound is a vinyl functional polyalkylene ether or a compound of the formula H₂C═CHR⁷, wherein R⁷ is a perfluoroalkyl group (e.g., having 6 to 20 carbon atoms) or a linear alkyl group (e.g., having 6 to 20 carbon atoms). In other embodiments, in the —OSiR²R³(CH₂)ₓN⁺R⁴R⁵R⁶ group, R², R³, R⁴ and R⁵ are alkyl; and R⁶ is an alkyl, cycloalkyl or aralkyl group containing at least 6 carbon atoms.

In yet another aspect, compositions are provided having a polymer and a compound having a silsesquioxane cage structure of a general formula [R¹SiO_{1.5}]ₙ, where n is an integer greater than or equal to 4; and each R¹ is independently an amine-functional siloxy group, a quaternary ammonium-functional siloxy group, a texturizing moiety, or a cross-linkable group. In some embodiments, the polymer is a thermoplastic polymer, an elastomeric polymer, or a blend thereof. In other embodiments, such compositions may be incorporated into biocidal and/or anti-microbial compositions and/or devices.

In a further aspect, compositions having a silsesquioxane cage structure of a general formula [R¹SiO_{1.5}]ₙ, where n is an integer greater than or equal to 4; and each R¹ is independently an amine-functional siloxy group, a quaternary ammonium-functional siloxy group, a texturizing moiety, or a cross-linkable group, may be prepared. In some embodiments, such compositions may be biocidal and/or anti-microbial.

In another aspect, methods of preparing biocidal coatings are provided. In some embodiments, the methods include reacting a mixture comprising a tertiaryamino-functional polyhedral oligomeric silsesquioxane and/or a tertiaryamino-functional polydimethylsiloxane; and a halo-functional polyhedral oligomeric silsesquioxane and/or a halo-functional polydimethylsiloxane, wherein the halide is Cl, Br, and/or I, and wherein the reaction mixture includes at least one of the tertiaryamino functional polyhedral oligomeric silsesquioxane and the haloalkyl-functional polyhedral oligomeric silsesquioxane. In some embodiments, the halide is Cl. In some embodiments, the tertiaryamino-functional silsesquioxane cage compound has general formula [R¹SiO_{1.5}]ₙ, where, each R¹ is independently a —OSiR²R³(CH₂)ₓNR⁴R⁵ group or a texturizing moiety, and at least one R¹ is a —OSiR²R³(CH₂)ₓNR⁴R⁵ group; x is an integer from 2 to 25; n is an integer greater than or equal to 4; R² and R³ are independently H, alkyl, cycloalkyl, aralkyl, or aryl; and R⁴ and R⁵ are independently H, alkyl, cycloalkyl, aryl, or R⁴ and R⁵, along with the N, form a heterocycloalkyl. In some embodiments, the tertiaryamino-functional polydimethylsiloxane is represented by the formula:

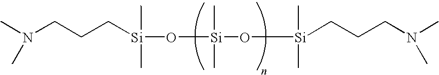

where n is and integer from 10 to 1,000. In some embodiments, n is an integer from 10 to 50. In some embodiments, the halo-functional polyhedral oligomeric silsesquioxane cage compound has general formula [R¹SiO_{1.5}]ₙ, where, each R¹ is independently a haloalkyl group, such as a —OSiR²R³(CH₂)_{y}X group, or a texturizing moiety, and at least one R¹ is a haloalkyl group; y is an integer from 2 to 25; n is an integer greater than or equal to 4; R² and R³ are independently H, alkyl, cycloalkyl, aralkyl, or aryl; and X is Cl, Br, and/or I, and where the reaction mixture includes at least one of the tertiaryamino functional polyhedral oligomeric silsesquioxane and the haloalkyl-functional polyhedral oligomeric silsesquioxane. In some embodiments, the halo-functional polydimethylsiloxane is represented by the formula:

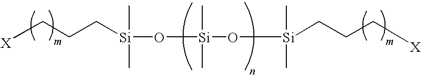

where n is an integer from 10 to 1,000, m is an integer from 0 to 25, and X is Cl, Br, or I. In some embodiments, n is an integer from 10 to 50.

In another aspect, a biocidal coating is prepared by a method including reacting a mixture including a tertiaryamino-functional polyhedral oligomeric silsesquioxane and/or a-tertiaryamino-functional polydimethylsiloxane; and a halo-functional polyhedral oligomeric silsesquioxane and/or a halo-functional polydimethylsiloxane, wherein the halide is Cl, Br, and/or I, and wherein the reaction mixture includes at least one of the tertiaryamino functional polyhedral oligomeric silsesquioxane and the haloalkyl-functional polyhedral oligomeric silsesquioxane. In some embodiments, the halide is Cl. In some embodiments, the tertiaryamino-functional silsesquioxane cage compound has general formula [R¹SiO_{1.5}]ₙ, where, each R¹ is independently a —OSiR²R³(CH₂)ₓNR⁴R⁵ group or a texturizing moiety, and at least one R¹ is a —OSiR²R³(CH₂)ₓNR⁴R⁵ group; x is an integer from 2 to 25; n is an integer greater than or equal to 4; R² and R³ are independently H, alkyl, cycloalkyl, aralkyl, or aryl; and R⁴ and R⁵ are independently H, alkyl, cycloalkyl, aryl, or R⁴ and R⁵, along with the N, form a heterocycloalkyl. In some embodiments, the tertiaryamino-functional polydimethylsiloxane is represented by the formula:

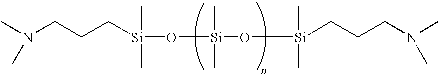

where n is and integer from 10 to 1,000. In some embodiments, n is an integer from 10 to 50. In some embodiments, the haloalkyl-functional polyhedral oligomeric silsesquioxane cage compound has general formula [R¹SiO_{1.5}]ₙ, where, each R¹ is independently a haloalkyl group, such as a —OSiR²R³(CH₂)_{y}X group, or a texturizing moiety, and at least one R¹ is a haloalkyl group; y is an integer from 2 to 25; n is an integer greater than or equal to 4; R² and R³ are independently H, alkyl, cycloalkyl, aralkyl, or aryl; and X is Cl, Br, and/or I. In some embodiments, the halide-functional polydimethylsiloxane is represented by the formula:

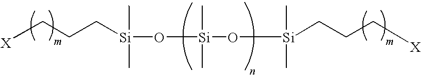

where n is an integer from 10 to 1,000, m is an integer from 0 to 25, and X is Cl, Br, or I. In some embodiments, n is an integer from 10 to 50.

In another aspect, methods of preparing biocidal coatings are provided. In some embodiments, the methods include reacting a mixture comprising: (A) a tertiaryamino-functional polyhedral oligomeric silsesquioxane and/or a tertiaryamino-functional polydimethylsiloxane; and (B) a halide-functional polyhedral oligomeric silsesquioxane and/or a halide-functional polydimethylsiloxane, wherein the halide is Cl, Br, and/or I, and where the reaction mixture includes at least one of the tertiaryamino-functional polyhedral oligomeric silsesquioxane and the haloalkyl-functional polyhedral oligomeric silsesquioxane.

In another aspect, a biocidal coating is prepared by a method comprising reacting a mixture comprising: (A) a tertiaryamino-functional polyhedral oligomeric silsesquioxane and/or a tertiaryamino-functional polydimethylsiloxane; and (B) a halide-functional polyhedral oligomeric silsesquioxane and/or a halo-functional polydimethylsiloxane, wherein the halide is Cl, Br, and/or I, and where the reaction mixture includes at least one of the tertiaryamino-functional polyhedral oligomeric silsesquioxane and the haloalkyl-functional polyhedral oligomeric silsesquioxane.

One skilled in the art will readily realize that all ranges discussed can and do necessarily also describe all subranges therein for all purposes and that all such subranges also form part and parcel of this invention. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

While several, non-limiting examples have been illustrated and described, it should be understood that changes and modifications can be made therein in accordance with ordinary skill in the art without departing from the invention in its broader aspects as defined in the following claims.

What is claimed is:

1. A compound comprising:
a silsesquioxane cage structure of a general formula [R¹SiO_{1.5}]ₙ, wherein,
n is an integer greater than or equal to 4;
each R¹ is independently an amine-functional siloxy group, a quaternary ammonium-functional siloxy group, a texturizing moiety or a cross-linkable group; and
at least about 25% of the R¹ groups are quaternary ammonium-functional siloxy groups, amine-functional siloxy groups, or a combination thereof.

2. The compound of claim 1, wherein the silsesquioxane cage structure includes compounds represented by the formula:

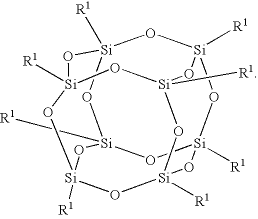

3. The compound of claim 1, wherein:
the amine-functional siloxy group is a group of formula —OSiR²R³(CH₂)ₓNR⁴R⁵;
R² and R³ are independently alkyl, cycloalkyl, aralkyl, or aryl;
R⁴ and R⁵ are independently H, alkyl, cycloalkyl, aralkyl, aryl, or R⁴ and R⁵, along with the N, form a heterocycloalkyl; and
x is an integer from 2 to 25.

4. The compound of claim 1, wherein:
the quaternary ammonium-functional siloxy group is a group of formula —OSiR²R³(CH₂)ₓN⁺R⁴R⁵R⁶;
R² and R³ are independently alkyl, cycloalkyl, aralkyl, or aryl;
R⁴ and R⁵ are independently H, alkyl, cycloalkyl, aralkyl, aryl, or R⁴ and R⁵, along with the N, form a heterocycloalkyl;
R⁶ is H, alkyl, cycloalkyl, or aralkyl; and
x is an integer from 2 to 25.

5. The compound of claim 4, wherein about 25% to 75% of the R¹ groups are quaternary ammonium-functional siloxy groups.

6. A method of producing the compound of claim 1 comprising:
reacting a silsesquioxane cage compound of formula [R²R³HSiOSiO_{1.5}]ₙ with a compound of formula H₂C═CH(CH₂)ₓNR⁴R⁵ and a vinyl functional texturizing compound to form an amine-functional silsesquioxane cage compound;
wherein x is an integer from 2 to 25;
n is an integer greater than or equal to 4;
R² and R³ are independently alkyl, cycloalkyl, aralkyl, or aryl; and
R⁴ and R⁵ are independently H, alkyl, cycloalkyl, aryl, or R⁴ and R⁵, along with the N atom form a heterocycloalkyl group;
wherein the silsesquioxane cage compound is a polyhedral oligomeric silsesquioxane (POSS).

7. A method of producing the compound of claim 1 comprising:
reacting a compound of formula H₂C═CH(CH₂)ₓNR⁴R⁵ with a polyhedral oligomeric silsesquioxane (POSS) of formula [R¹SiO_{1.5}]ₙ, where, each R¹ is independently a —OSiHR²R³ group or a texturizing moiety to form an amine-functional silsesquioxane cage compound;
wherein,
x is an integer from 2 to 25;
n is an integer greater than or equal to 4;
R² and R³ are independently H, alkyl, cycloalkyl, aralkyl, or aryl;
R⁴ and R⁵ are independently H, alkyl, cycloalkyl, aryl, or R⁴ and R⁵, along with the N, form a heterocycloalkyl; and
at least one R¹ is a —OSiHR²R³ group.

8. The method of claim 7, further comprising:
reacting the amine-functional silsesquioxane cage compound with a compound of formula R⁶X to form a quaternary ammonium-functional polyhedral oligomeric silsesquioxane;
wherein;
R⁶ is an alkyl, cycloalkyl or aralkyl group; and
X is a halogen or an R⁶SO₄— group.

9. A biocidal composition comprising polymeric material and the compound of claim 1.

10. The biocidal composition of claim 9, wherein the polymer material comprises a thermoplastic polymer, an elastomeric polymer, or a blend thereof.

11. The biocidal composition of claim 9, wherein the biocidal composition is a coating on a substrate surface.

12. The biocidal coating of claim 11, wherein the coating comprises:
at least about 75 wt. % polydialkyl siloxane; and
about 5 to 25 wt. % of the compound of claim 3; wherein the quaternary ammonium-functional siloxy groups are represented by the formula
—OSiR²R³(CH₂)ₓN⁺R⁴R⁵R⁶; and
R⁶ is C₁₀-C₁₈ n-alkyl.

13. The biocidal coating of claim 12, wherein about 25% to 75% of the R¹ groups are quaternary ammonium-functional siloxy groups.

14. The biocidal coating of claim 11 wherein the coating is a cross-linked polysiloxane coating.

15. The biocidal coating of claim 11 comprising the silsesquioxane cage structure wherein n is 8.

16. The biocidal coating of claim 12, wherein R², R³, R⁴, and R⁵ are methyl; x is an integer from 2 to 4; and quaternary ammonium-functional siloxy groups include groups wherein R⁶ is C₁₂ n-alkyl.

17. The biocidal coating of claim 12, wherein R², R³, R⁴, and R⁵ are methyl; x is an integer from 2 to 4; and quaternary ammonium-functional siloxy groups include groups wherein R⁶ is C₁₆ n-alkyl.

18. The biocidal coating of claim 12, wherein R², R³, R⁴, and R⁵ are methyl; x is an integer from 2 to 4; and quaternary ammonium-functional siloxy groups include groups wherein R⁶ is C₁₈ n-alkyl.

19. A method of producing a biocidal coating, comprising:
reacting a mixture comprising:
(A) a tertiaryamino-functional polyhedral oligomeric silsesquioxane and/or an amino-functional polydimethylsiloxane; and
(B) a halo-functional polyhedral oligomeric silsesquioxane and/or a halo-functional polydimethylsiloxane, wherein the halide is Cl, Br, and/or I; and
wherein the reaction mixture includes at least one of the tertiaryamino-functional polyhedral oligomeric silsesquioxane and the haloalkyl-functional polyhedral oligomeric silsesquioxane.

20. A biocidal coating prepared by a method comprising:
reacting a mixture comprising:
(A) a tertiaryamino-functional polyhedral oligomeric silsesquioxane and/or an amino-functional polydimethylsiloxane; and
(B) a haloalkyl-functional polyhedral oligomeric silsesquioxane and/or a halo-functional polydimethylsiloxane, wherein the halide is Cl, Br, and/or I; and
wherein the reaction mixture comprises at least one of the tertiaryamino-functional polyhedral oligomeric silsesquioxane and the haloalkyl-functional polyhedral oligomeric silsesquioxane.
